(19) United States
(12) Patent Application Publication
(10) Pub. No.: US 2020/0252006 A1
(43) Pub. Date: Aug. 6, 2020

(54) Vibration Energy Harvesting Apparatus, Vibration Energy Harvesting Apparatus Kit, Mounting Structure for Vibration Energy Harvesting Apparatus, Vibration Energy Harvesting Device, and Adapter

(71) Applicant: Saginomiya Seisakusho, Inc., Tokyo (JP)

(72) Inventor: Daisuke ANAI, Sayama-shi (JP)

(21) Appl. No.: 16/774,396

(22) Filed: Jan. 28, 2020

(30) Foreign Application Priority Data
Jan. 31, 2019 (JP) 2019-015755

(51) Int. Cl. H02N 1/08; H01F 7/02

(52) U.S. Cl. CPC H02N 1/08; H01F 7/02

(57) ABSTRACT

A vibration energy harvesting apparatus includes: a vibration energy harvesting device in which at least a vibration energy harvester is housed in a casing; an adapter disposed between the casing and a vibration source; and a permanent magnet that locks the casing and the adapter together with magnetic force, wherein: the permanent magnet is disposed at least either inside the casing or at the adapter.

### INCORPORATION BY REFERENCE

The disclosure of the following priority application is herein incorporated by reference: Japanese Patent Application No. 2019-015755, filed Jan. 31, 2019

### TECHNICAL FIELD

The present invention relates to a vibration energy harvesting apparatus, a vibration energy harvesting apparatus kit, a mounting structure for a vibration energy harvesting apparatus, a vibration energy harvesting device and an adapter.

### BACKGROUND ART

The development of technologies through which vibration energy, generated through vibration occurring in the environment, is converted to electric power via a compact vibration energy harvester formed through an MEMS technology has been pursued in earnest in recent years. PTL1 teaches that electric power is generated by causing a movable portion having a comb electrode formed thereat to vibrate relative to a fixed portion with a comb electrode formed thereat. Such a resonance-type vibration energy harvester needs to be installed in such a way that it is able to generate electric power efficiently under the particular conditions in which an environmental vibration occurs.

### CITATION LIST

### Patent Literature

PTL1: Japanese Patent No. 6338071

### SUMMARY OF INVENTION

### Technical Problem

PTL1 mentioned above does not include any description pertaining to a mounting structure with which a vibration energy harvester may be mounted at a vibration source. This means that the vibration energy harvester needs to be installed by determining in advance an optimal mounting location with respect to the vibration conditions under which the vibration source vibrates.

### Solution to Problem

According to a 1st aspect of the present invention, a vibration energy harvesting apparatus, comprises: a vibration energy harvesting device in which at least a vibration energy harvester is housed in a casing; an adapter disposed between the casing and a vibration source; and a permanent magnet that locks the casing and the adapter together with magnetic force, wherein: the permanent magnet is disposed at least either inside the casing or at the adapter.

According to a 2nd aspect of the present invention, the vibration energy harvesting apparatus according to the 1st aspect may further comprise: a locking member that locks the adapter to the vibration source either directly or via an attachment.

According to a 3rd aspect of the present invention, in the vibration energy harvesting apparatus according to the 2nd aspect, it is preferable that the adapter includes a locking member mounting portion used to mount the locking member.

According to a 4th aspect of the present invention, in the vibration energy harvesting apparatus according to the 2nd aspect, it is preferable that the adapter includes at least an attraction-type locking portion of a magnetic material and the permanent magnet is disposed at least inside the casing.

According to a 5th aspect of the present invention, in the vibration energy harvesting apparatus according to the 3rd aspect, it is preferable that the permanent magnet is disposed at the locking member mounting portion of the adapter and the casing includes an attraction-type locking portion of a magnetic material.

According to a 6th aspect of the present invention, in the vibration energy harvesting apparatus according to the 3rd aspect, it is preferable that the adapter is locked to a bottom portion of the casing; and the locking member mounting portion at the adapter is disposed within an area that overlaps the bottom portion of the casing in a plan view.

According to a 7th aspect of the present invention, in the vibration energy harvesting apparatus according to the 6th aspect, it is preferable that a protruding portion used for positioning or rotation prevention is disposed either at the adapter or at the bottom portion of the casing, and a protruding portion insertion portion at which the protruding portion is inserted is disposed at either the adapter or at the bottom portion of the casing where the protruding portion is absent.

According to an 8th aspect of the present invention, in the vibration energy harvesting apparatus according to the 3rd aspect, it is preferable that the adapter includes a casing locking portion to be locked to the casing and a vibration source locking portion to be locked to the vibration source or to the attachment, and the casing locking portion and the vibration source locking portion are connected with each other at an intersecting area with one inclined at a predetermined angle relative to another.

According to a 9th aspect of the present invention, in the vibration energy harvesting apparatus according to the 2nd aspect, it is preferable that the locking member includes a plurality of permanent magnets that lock the adapter and the vibration source together with magnetic force, disposed at positions set apart from one another.

According to a 10th aspect of the present invention, in the vibration energy harvesting apparatus according to the 3rd aspect, it is preferable that the locking member mounting portion at the adapter includes a plurality of locking member mounting portions used to mount a plurality of different types of locking members.

According to an 11th aspect of the present invention, a vibration energy harvesting apparatus kit, comprises: a vibration energy harvesting device in which at least a vibration energy harvester is housed in a casing; and an adapter disposed between the casing and a vibration source, wherein the casing and the adapter are locked together with magnetic force by a permanent magnet disposed at least either inside the casing or at the adapter.

According to a 12th aspect of the present invention, in a mounting structure for the vibration energy harvesting apparatus according to the 2nd aspect, it is preferable that the adapter, to which the casing of the vibration energy harvesting device is locked with magnetic force, is locked to the vibration source via the locking member.

According to a 13th aspect of the present invention, the vibration energy harvesting device included in the vibration energy harvesting apparatus according to the 1st aspect.

According to a 14th aspect of the present invention, an adapter that locks a vibration energy harvesting device with magnetic force and is locked to a vibration source via a locking member, comprises: a plurality of locking member mounting portions used to mount a plurality of different types of locking members.

### Advantageous Effects of Invention

According to the present invention, a vibration energy harvesting device can be mounted on the vibration source at any position where it is able to generate electric power efficiently by determining the optimal mounting location according to the vibration conditions for the vibration source.

### BRIEF DESCRIPTION OF DRAWINGS

FIG. 1 is an exploded perspective view of a vibration energy harvesting apparatus according to an embodiment of the present invention.

FIG. 2 is an exploded perspective view of the vibration energy harvesting apparatus in

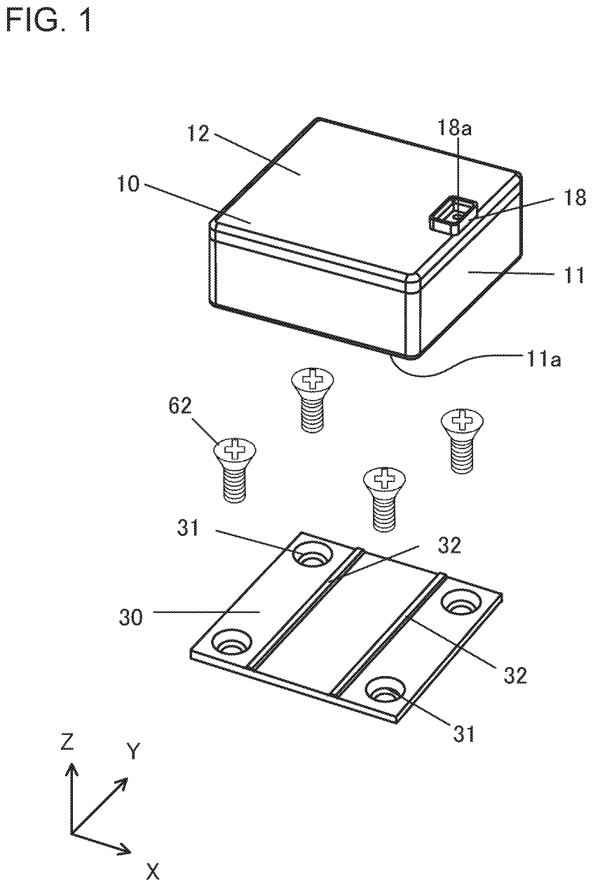

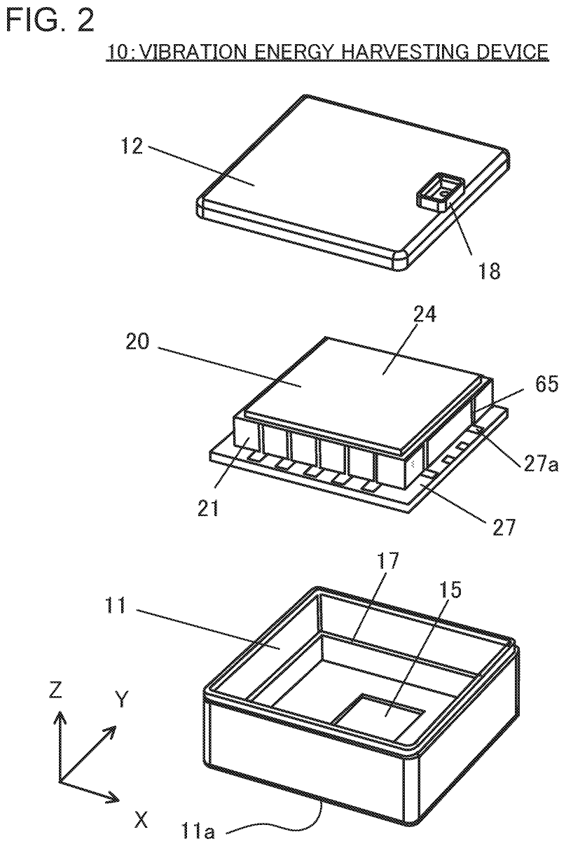

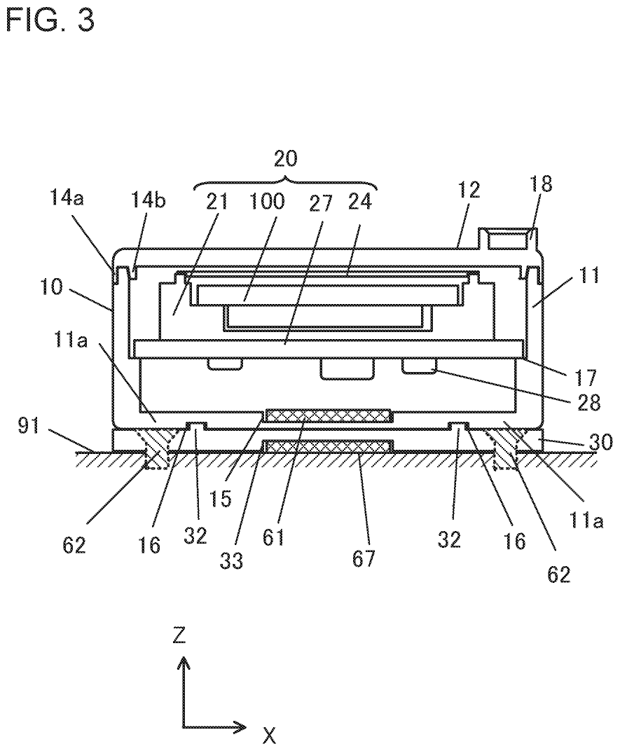

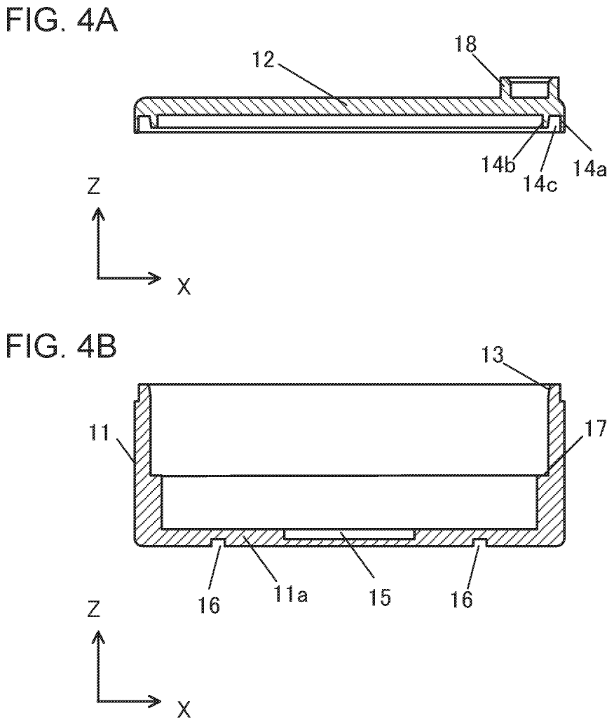

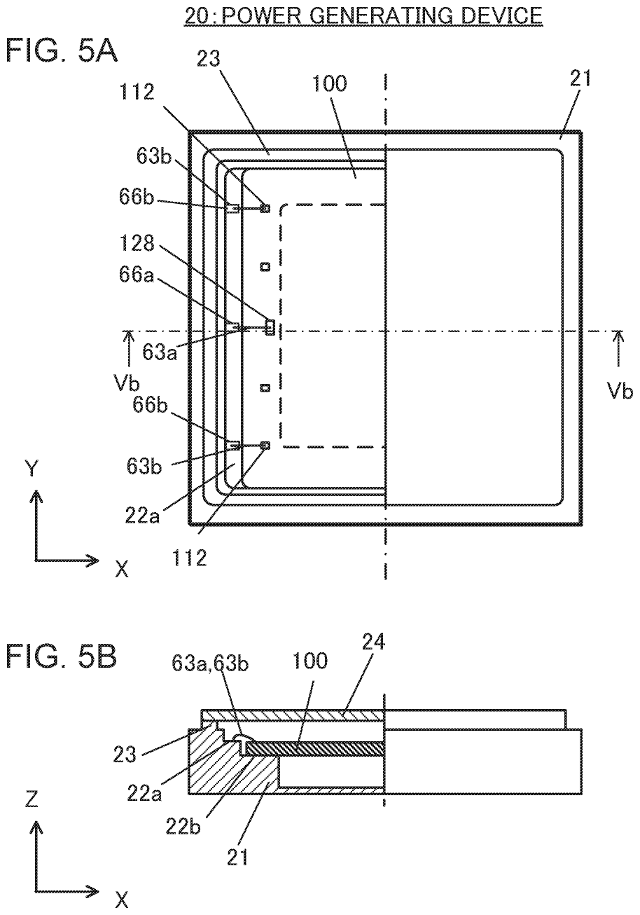

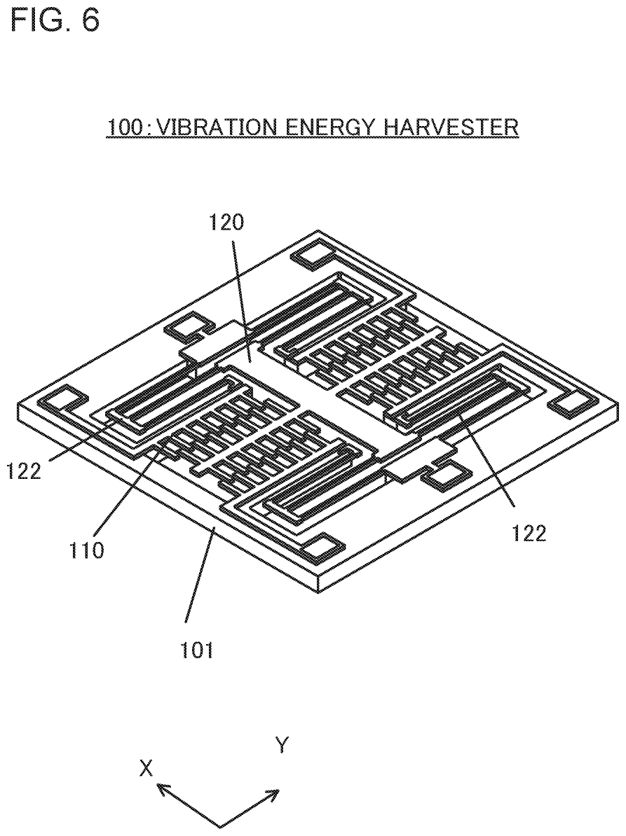

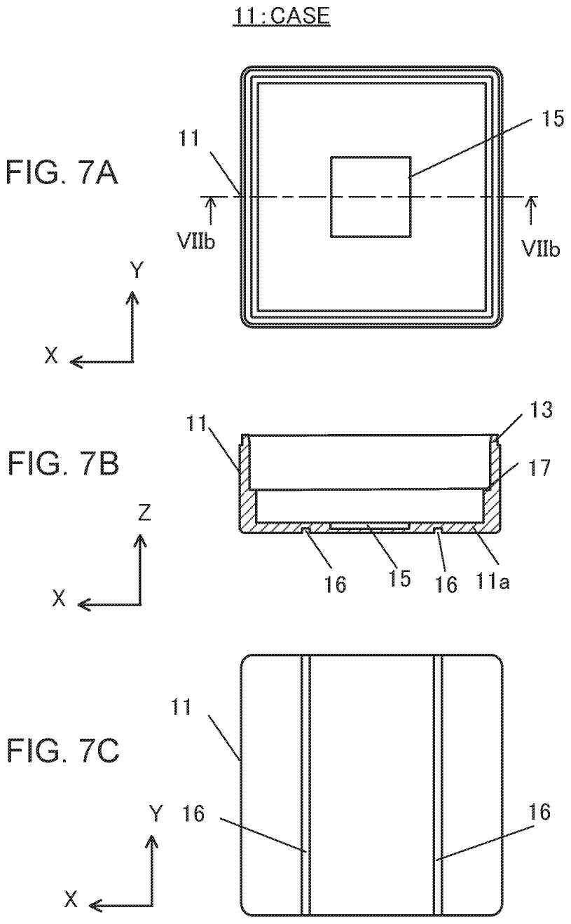

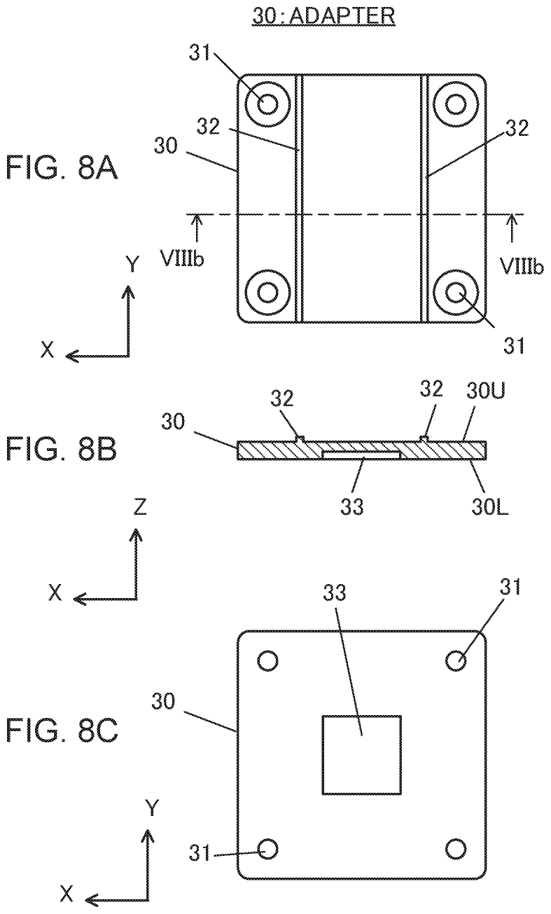

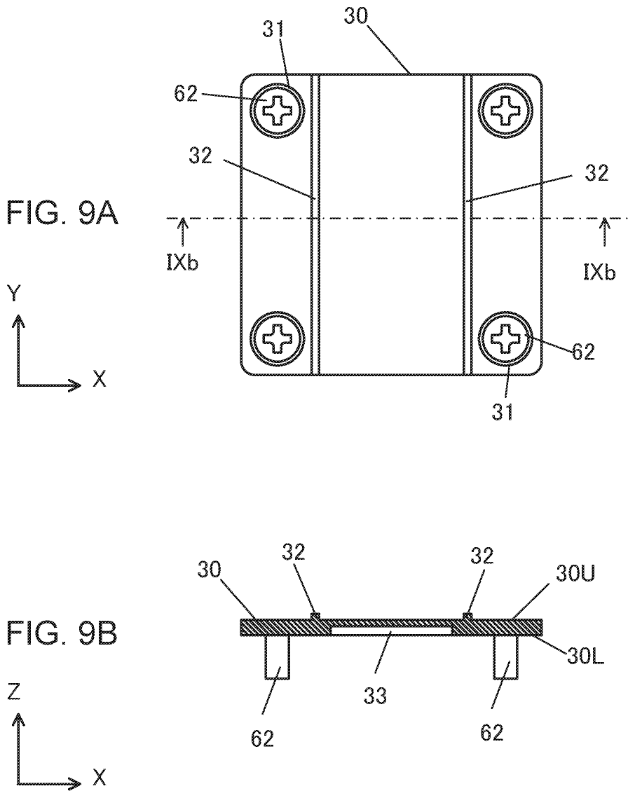

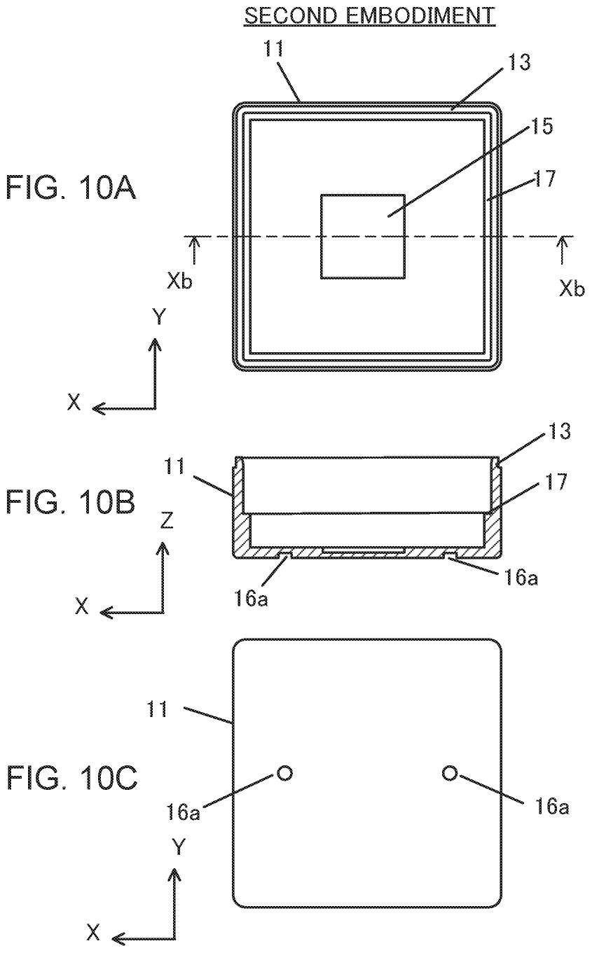

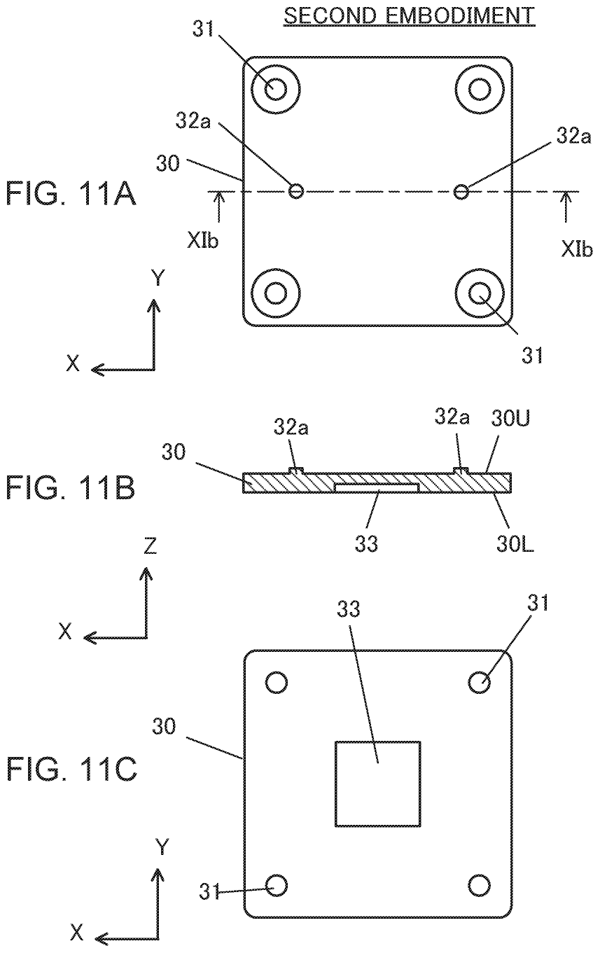

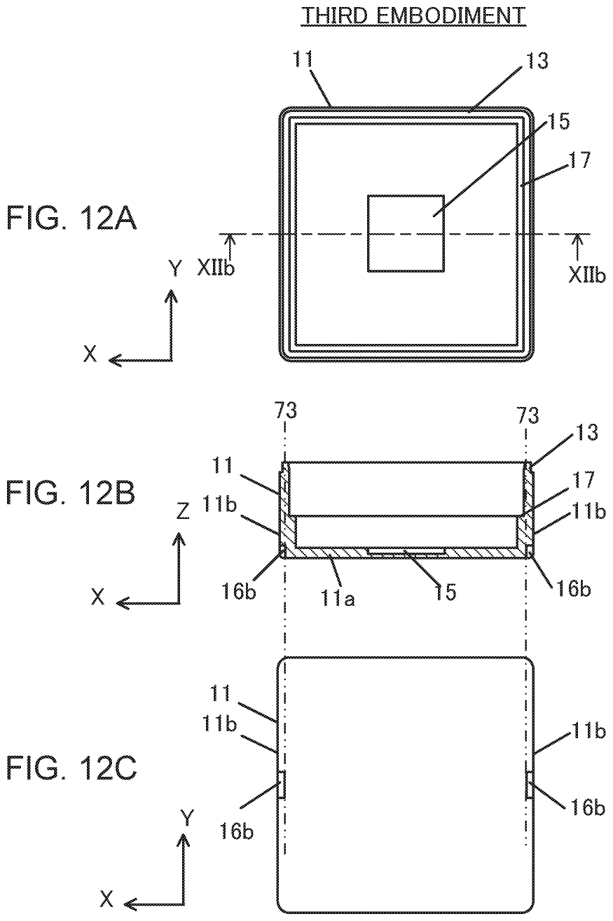

FIG. 1.

FIG. 3 is a longitudinal sectional view of the vibration energy harvesting apparatus in FIG. 1 mounted at a vibration source via an adapter.

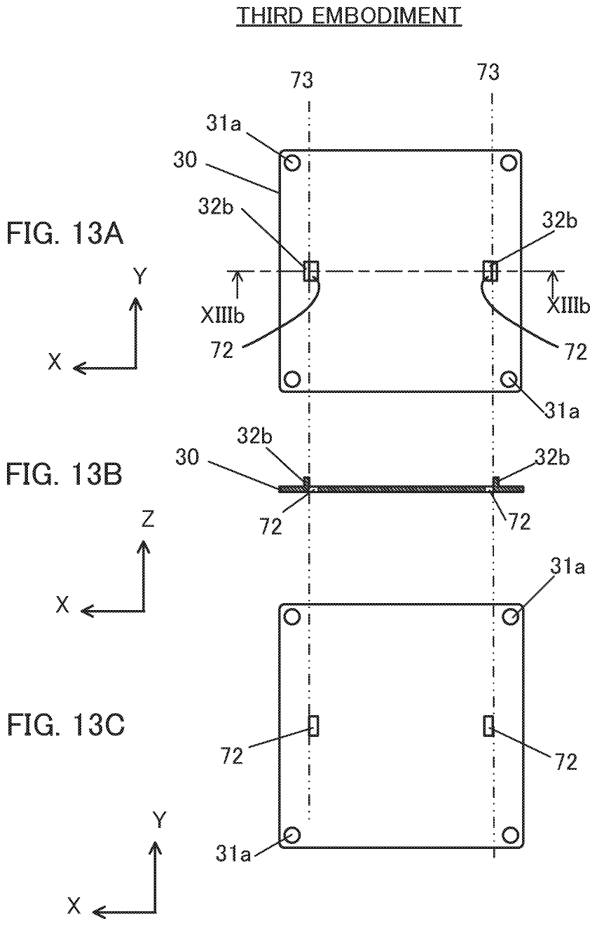

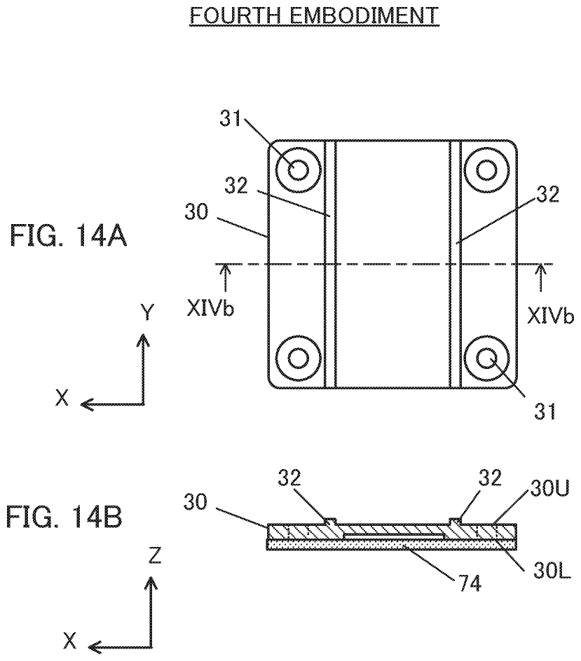

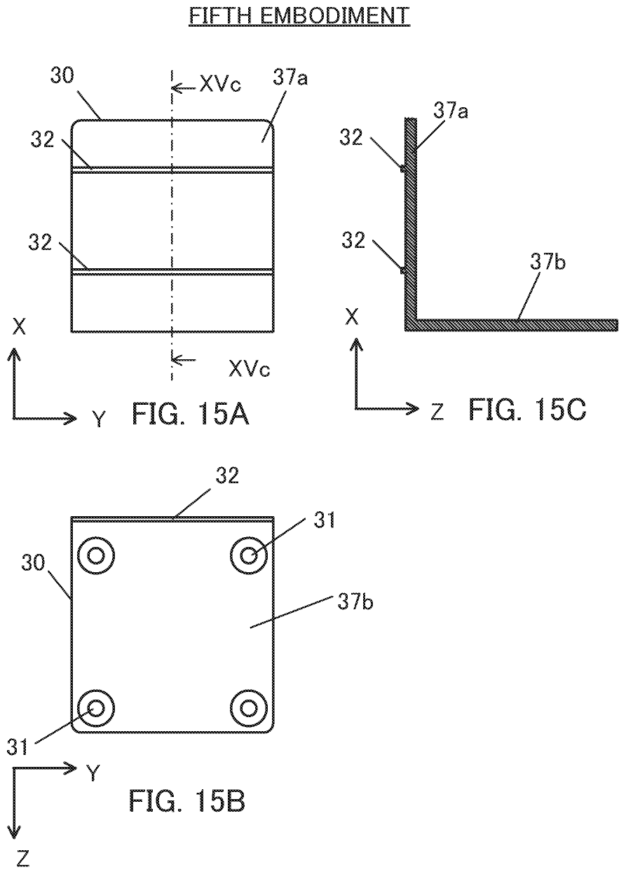

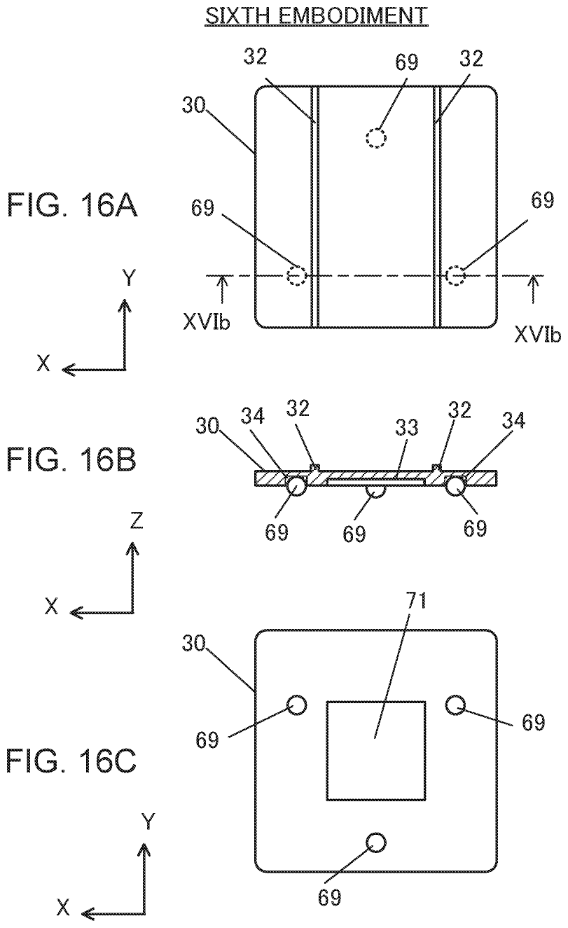

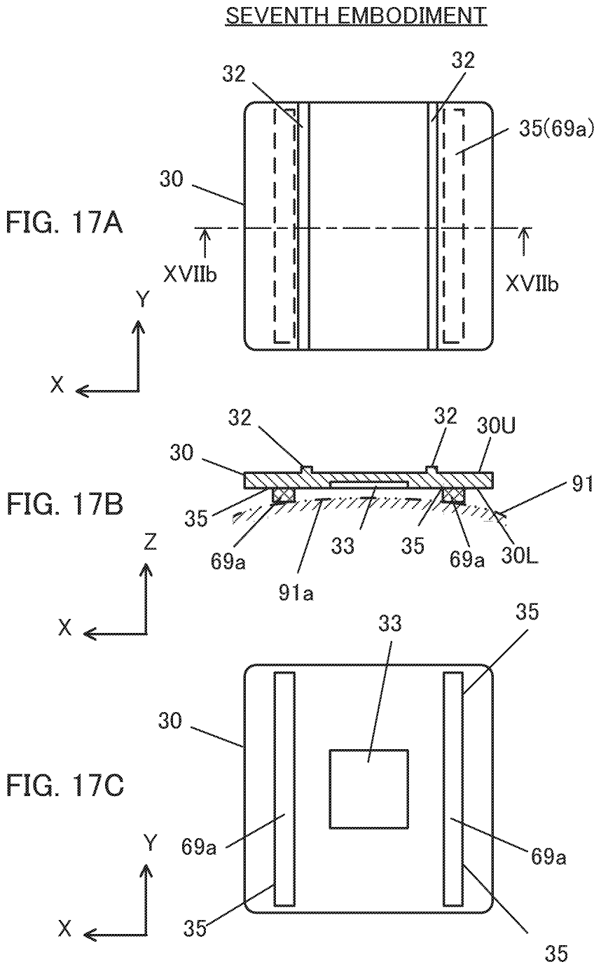

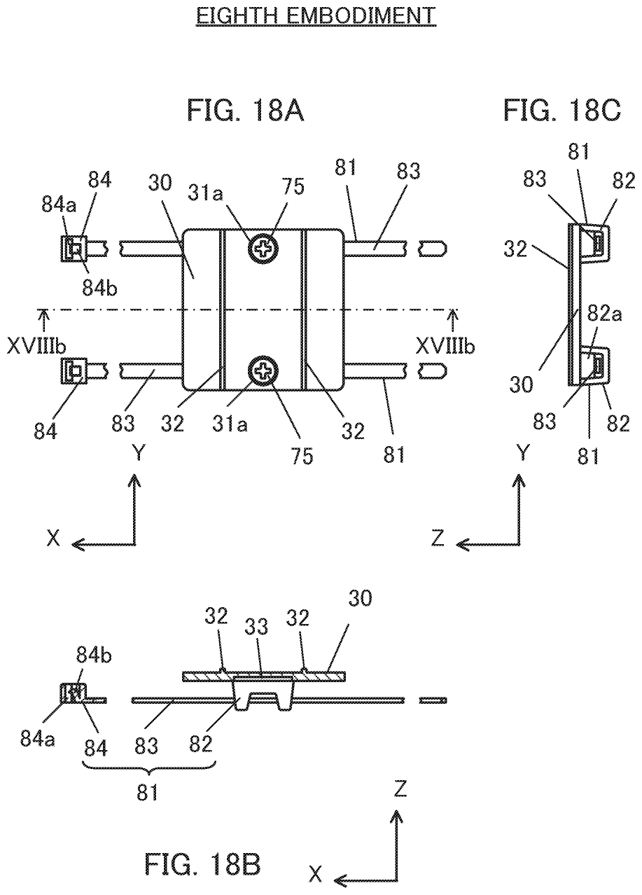

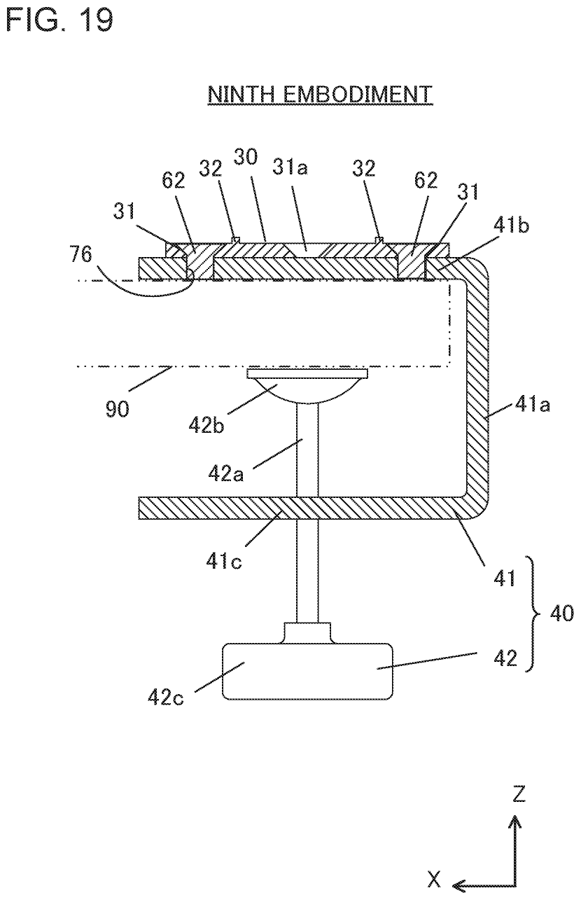

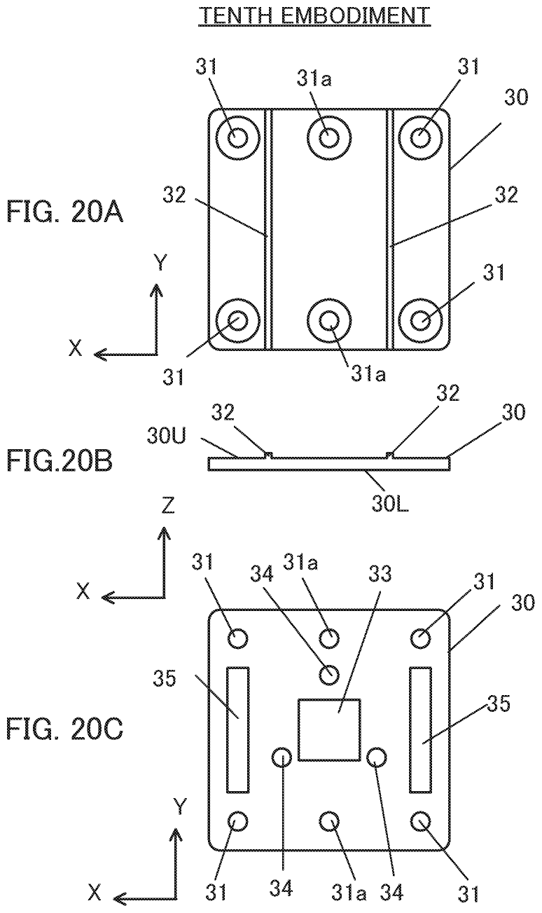

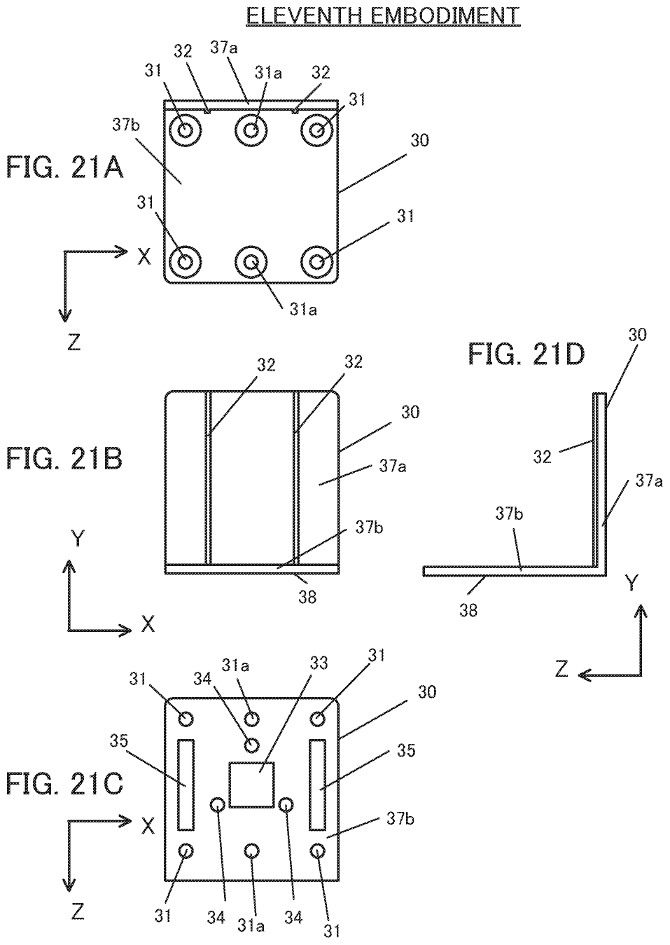

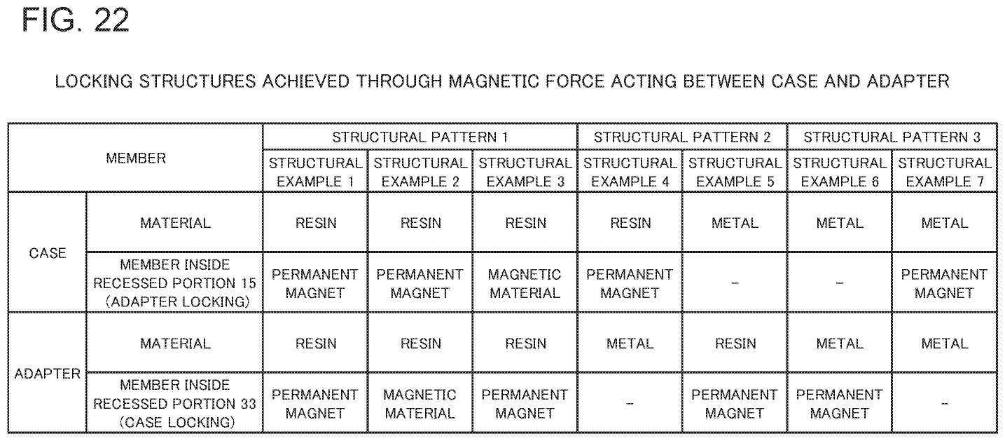

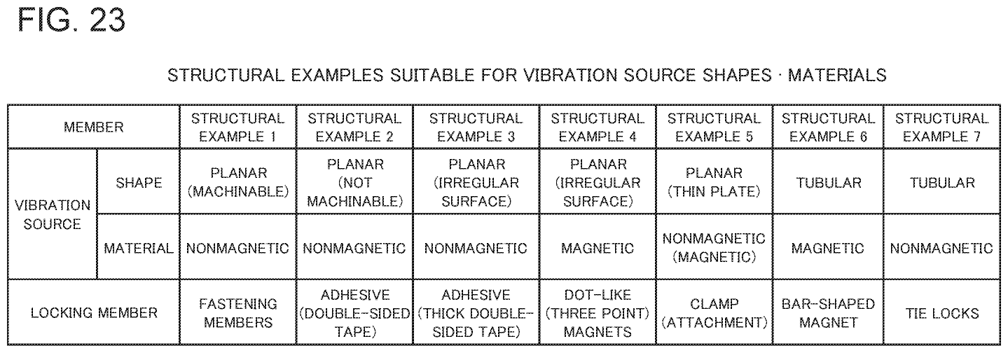

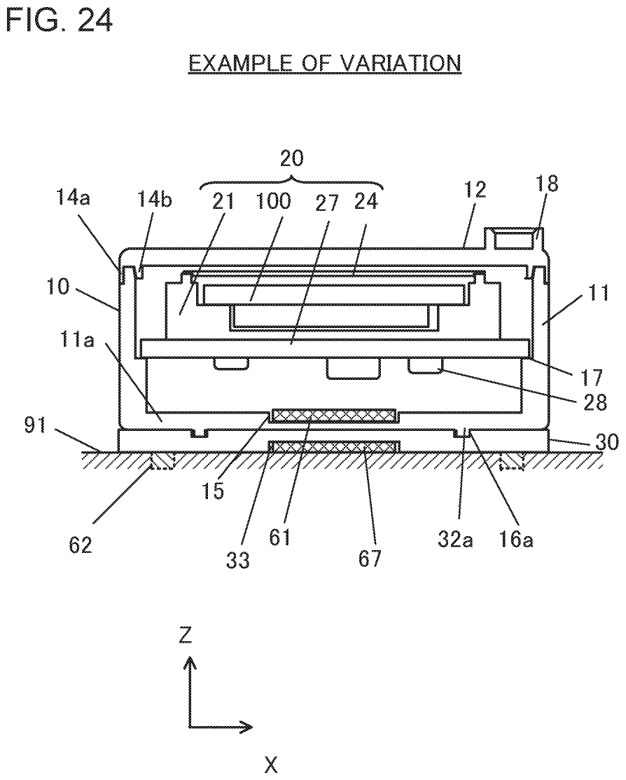

FIG. 4A is a longitudinal sectional view of a lid in FIG. 2 and FIG. 4B is a longitudinal sectional view of a case in FIG. 2.

FIGS. 5A and 5B show illustrations of a power generating device in FIG. 2, with FIG. 5A showing half of an upper cover in a partial transparent plan view and FIG. 5B showing the power generating device in a sectional view taken along Vb-Vb in FIG. 5A.

FIG. 6 is an external view of a vibration energy harvester in FIGS. 5A and 5B in a perspective.

FIGS. 7A to 7C show illustrations of the case in FIG. 2, with FIG. 7A showing a top view, FIG. 7B showing a sectional view taken along VIIb-VIIb in FIG. 7A and FIG. 7C showing a bottom view.

FIGS. 8A to 8C shows illustrations of the adapter in FIG. 1, with FIG. 8A showing a top view, FIG. 8B showing a sectional view taken along VIIIb-VIIIb in FIG. 8A and FIG. 8C showing a bottom view.

FIGS. 9A and 9B show illustrations of a structure achieved by attaching fastening members at the adapter in FIG. 1, with FIG. 9A showing a plan view and FIG. 9B showing a sectional view taken along IXb-IXb in FIG. 9A.

FIGS. 10A to 10C show illustrations of a second embodiment of the present invention, with FIG. 10A showing a case in a top view, FIG. 10B showing the case in a sectional view taken along Xb-Xb in FIG. 10A and FIG. 10C showing the case in a bottom view.

FIGS. 11A to 11C show illustrations of the adapter to be fixed to the case shown in FIGS. 10A through 10C, with FIG. 11A showing a top view, FIG. 11B showing a sectional view taken along XIb-XIb in FIG. 11A and FIG. 11C showing a bottom view.

FIGS. 12A to 12C show illustrations of a third embodiment of the present invention, with FIG. 12A showing a case in a top view, FIG. 12B showing the case in a sectional view taken along XIIb-XIIb in FIG. 12A and FIG. 12C showing the case in a bottom view.

FIGS. 13A to 13C show illustrations of the adapter to be fixed to the case shown in FIGS. 12A through 12C, with FIG. 13A showing a top view, FIG. 13B showing a sectional view taken along XIIIb-XIIIb in FIG. 13A and FIG. 13C showing a bottom view.

FIGS. 14A and 14B show illustrations of a fourth embodiment of the present invention, with FIG. 14A showing an adapter in a top view and FIG. 14B showing it in a sectional view taken along XIVb-XIVb in FIG. 14A.

FIGS. 15A to 15C show illustrations of a fifth embodiment of the present invention, with FIG. 15A showing an adapter in a front view, FIG. 15B showing the adapter in a bottom view and FIG. 15C showing the adapter in a sectional view taken along XVc-XVc in FIG. 15A.

FIGS. 16A to 16C show illustrations of a sixth embodiment of the present invention, with FIG. 16A showing an adapter with three locking members included therein in a top view, FIG. 16B showing the adapter in a sectional view taken along XVIb-XVIb in FIG. 16A and FIG. 16C showing the adapter with the locking members in a bottom view.

FIGS. 17A to 17C show illustrations of a seventh embodiment of the present invention, with FIG. 17A showing an adapter with locking members included therein in a top view, FIG. 17B showing a sectional view taken along XVIIb-XVIIb in FIG. 17A and FIG. 17C showing the adapter with the locking members in a bottom view.

FIGS. 18A to 18C show illustrations of an eighth embodiment of the present invention, with FIG. 18A showing an adapter with locking members included therein in a top view, FIG. 18B showing the adapter in a sectional view taken along XVIIIb-XVIIIb in FIG. 18A and FIG. 18C showing the adapter in FIG. 18A in a side elevation.

FIG. 19 is a sectional view of a ninth embodiment of the present invention.

FIGS. 20A to 20C show illustrations of a tenth embodiment of the present invention, with FIG. 20A showing an adapter in a top view, FIG. 20B showing the adapter in FIG. 20A in a side elevation and FIG. 20C showing the adapter in a bottom view.

FIGS. 21A to 21D show illustrations of an eleventh embodiment of the present invention, with FIG. 21A showing an adapter in a top view, FIG. 21B showing the adapter in a plan view, FIG. 21C showing the adapter in a bottom view and FIG. 21D showing the adapter in FIG. 21B in a side elevation.

FIG. 22 shows a chart presenting examples of locking structures achieved through magnetic force between the case and the adapter.

FIG. 23 shows a chart presenting examples of locking structures suited to specific shapes and materials of the vibration source.

FIG. 24 is a sectional view presenting an example of a variation of the vibration energy harvesting apparatus according to the present invention.

### DESCRIPTION OF EMBODIMENTS

A vibration energy harvesting apparatus according to the present invention affords better ease of operation when a vibration energy harvesting device is mounted at or dismounted from a vibration source and also allows the vibration energy harvesting device to be mounted at a different installation location instead of having to discard the vibration energy harvesting device when the installation location is switched. For this purpose, the vibration energy harvesting apparatus according to the present invention is configured to fix an adapter to the vibration energy harvesting device with magnetic force and any of the following modes may be adopted.

(1) A permanent magnet is disposed at the vibration energy harvesting device and the adapter is manufactured by using a magnetic material.
(2) A permanent magnet is disposed at the vibration energy harvesting device and a magnetic material is disposed at a part of the adapter.
(3) A permanent magnet is disposed at the adapter and the vibration energy harvesting device is manufactured by using a magnetic material.
(4) A permanent magnet is disposed at the adapter and a magnetic material is disposed at a part of the vibration energy harvesting device.
(5) Permanent magnets are disposed at both the vibration energy harvesting device and the adapter.

In the embodiments to be described below, the vibration energy harvesting device is configured by housing a vibration energy harvester and a substrate, which is a circuit body with an electric circuit mounted thereat, inside a case as built-in members, and the case is constituted of metal or resin. The adapter is a flat plate member constituted of metal or resin.

### First Embodiment

In reference to FIGS. 1 through 9B, the first embodiment of the present invention will be explained.

FIG. 1 is an exploded perspective view of a vibration energy harvesting apparatus according to an embodiment of the present invention. FIG. 2 is an exploded perspective view of a vibration energy harvesting device 10 in FIG. 1, whereas FIG. 3 shows the vibration energy harvesting device 10 mounted at a vibration source via an adapter 30 in a longitudinal sectional view. FIG. 4A is a longitudinal sectional view of a lid in FIG. 2 and FIG. 4B is a longitudinal sectional view of a case in FIG. 2.

In the following description, orientations of the device and members will be indicated in relation to an XYZ coordinate system in the figures. The vibration energy harvesting apparatus shown in FIG. 1 includes a structure that allows the vibration energy harvesting device to be mounted at a vibration source (not shown). As shown in FIG. 1, the vibration energy harvesting apparatus comprises the vibration energy harvesting device 10 and the adapter 30. The vibration energy harvesting device 10 includes a vibration energy harvester 100 (see FIG. 6) and a permanent magnet 61 (see FIG. 3) housed inside a case 11. The adapter 30 is fixed to the bottom surface of the vibration energy harvesting device 10 with the permanent magnet 61 in such a way that it can be freely attached to and detached from the vibration energy harvesting device 10. The adapter 30 is locked to the vibration source (not shown) via fastening members 62 such as bolts. The dimensions of the vibration energy harvesting device 10 may be, for instance, 30 through 50 mm in length, 30 through 50 mm in width and 10 through 20 mm in height.

The adapter 30, constituted of resin, is a plate member assuming the shape of a substantially flat rectangle. Near the four corners of the adapter 30, through holes 31, at which the fastening members 62, such as screws or bolts, are inserted, are formed. In addition, at a rectangular surface (front surface) of the adapter 30, which faces opposite a bottom portion 11a of the vibration energy harvesting device 10, two protruding portions 32, ranging over the full length of the rectangular shape from one side of the rectangle through the opposite side, are formed so as to run straight and parallel to each other. In other words, the protruding portions 32 extend along the Y direction.

As shown in FIG. 2, the vibration energy harvesting device 10 is configured with the case 11, a lid 12 and a power generating device 20. The case 11 and the lid 12 are formed with a non-magnetic material such as resin. The case 11 is formed in the shape of a box with an open top. The bottom portion 11a of the case 11 constitutes the bottom of the vibration energy harvesting device 10. As FIG. 3 illustrates, the lid 12 is locked to the case 11 so as to cover the opening of the case 11. At the lid 12, a wiring outlet portion 18, through which a connector wiring (not shown) extending from a circuit body 27 is inserted, is formed as an integrated part thereof. At the wiring outlet portion 18, an opening 18a (see FIG. 1) is formed and thus, the connector wiring is drawn to the outside through the opening 18a. Once the connector wiring is drawn to the outside, the opening 18a is filled with an adhesive such as an epoxy resin for sealing. By sealing the opening 18a at the wiring outlet portion 18 after drawing out the connector wiring as described above, entry of moisture or the like into the vibration energy harvesting device 10 is prevented.

As shown in FIG. 4A and FIG. 4B, a continuous outer wall 14a and a continuous inner wall 14b are formed at the edge of the lid 12, with a continuous groove portion 14c formed between the continuous outer wall 14a and the continuous inner wall 14b. A continuous upper end 13 of the case 11 is fitted inside the continuous groove portion 14c at the lid 12 (see FIG. 3) and as the outer circumferential surface of the upper end 13 and the inner circumferential surface of the outer wall 14a are bonded to each other with an adhesive (not shown) such as an epoxy resin, the space inside becomes tightly sealed.

As FIG. 4B shows in detail, a recessed portion 15 for locking a magnet, assuming a rectangular shape in a plan view, to which the permanent magnet 61 is fixed, is formed at a substantially central area of the inner surface of the bottom portion 11a of the case 11. In addition, at the outer surface of the bottom portion 11a of the case 11, i.e., at the bottom surface of the case 11, two straight grooves 16 running parallel to each other along the Y direction are formed. Furthermore, a continuous staged portion 17 is formed at an intermediate point along the height wise direction (Z direction) at the inner wall of the case 11.

As will be explained later, the power generating device 20, installed at the staged portion 17, is housed inside the case 11, and the case 11 is sealed as the lid 12, covering the opening of the case 11, is adhered to the case 11.

Power Generating Device

The power generating device 20 will be described in reference to FIGS. 5A and 5B, as well as others. FIGS. 5A and 5B provide illustrations of the power generating device in FIG. 2, with FIG. 5A showing half of an upper cover in a partial transparent plan view and FIG. 5B showing it in a sectional view taken along Vb-Vb in FIG. 5A.

The power generating device 20 includes a power generation package 21, the vibration energy harvester 100, the circuit body 27 (see FIG. 2) used for power storage, and an upper cover 24. The vibration energy harvester 100, housed inside the power generation package 21, is fixed onto a staged portion 22b of the power generation package 21 with an insulating die bond material. The power generation package 21 is mounted at the circuit body 27 with an electrically conductive material such as solder.

The circuit body 27 is fixed to the staged portion 17 of the case 11 with an adhesive (not shown) such as an epoxy resin. The vibration energy harvester 100 (see FIG. 6) is housed inside the power generation package 21, and the power generation package 21 and the upper cover 24 are fused together through, for instance, seam welding by setting the inner space of the power generation package to a vacuum. This means that the power generating device 20 is a structural body that is internally sealed.

The circuit body 27 is configured by mounting electronic components 28 such as a diode that rectifies electric power obtained through power generation by the vibration energy harvester 100 and a power storage capacitor at a circuit substrate. As has been explained, the connector wiring (not shown) is connected to the circuit body 27, and power from the power generating device 20 is provided to a target device such as an analyzer or an information processing device as desired via the connector wiring drawn out through the wiring outlet portion 18.

The power generation package 21 of the power generating device 20 is formed by using, for instance, an electrically insulating material such as ceramic. At the power generation package 21, which assumes a rectangular shape in a plan view, an upper staged portion 22a and a lower staged portion 22b are formed on the inner surface in a middle area along the thickness wise direction. In addition, a continuous projection 23 is formed at the upper end of the power generation package 21. As has been explained earlier, the continuous projection 23 and the upper cover 24 are fused together through seam welding or the like.

The vibration energy harvester 100 is installed at the power generation package 21 by bonding it at the lower staged portion 22b with a die bonding material. Conductive pads 66a and 66b (see FIG. 5A) are formed at the upper staged portion 22a of the power generation package 21. The conductive pads 66a and 66b are connected to conductive pads 128 and 112 at the vibration energy harvester 100 via bonding wires 63a and 63b. The conductive pads 66a and 66b are connected to a wiring pattern 27a (see FIG. 2) formed at the upper surface of the circuit body 27 via connector leads 65 (see FIG. 2) patterned at the outer surface of the power generation package 21. The wiring pattern 27a at the circuit body 27 is connected to the connector wiring (not shown) and the connector wiring is drawn to the outside through the opening 18a of the wiring outlet portion 18 located at the lid 12 of the case 11.

It is to be noted that a fixed comb electrode 110 and a movable comb electrode 120, which will be described later, are not included in the illustration of the vibration energy harvester 100 in FIG. 5A.

Vibration Energy Harvester

FIG. 6 is an external view of the vibration energy harvester in FIGS. 5A and 5B in a perspective.

The vibration energy harvester 100 includes a base 101, a fixed comb electrode 110 and a movable comb electrode 120. The vibration energy harvester 100 is formed through a standard MEMS processing technology by using an SOI (silicone-on-insulator) substrate. An SOI substrate is a substrate having a three-layer structure made up with an Si base 101, an SIO₂ box layer (not shown) and an Si active layer, and the fixed comb electrode 110 and the movable comb electrode 120 are formed with the active layer. An electret is formed at either of, or both of the fixed comb electrode 110 and the movable comb electrode 120. The movable comb electrode 120 is elastically supported at the base 101 via elastic members 122. The movable comb electrode 120 moves relative to the fixed comb electrode 110 as it is caused to vibrate by an external vibration along the X direction, indicated as the vibrating direction in the figure. Through such relative displacement occurring with respect to the movable comb electrode 120 and the fixed comb electrode 110, AC power is generated.

The electric power, having been generated at the vibration energy harvester 100, is stored in an electronic component 28 (see FIG. 3) such as a capacitor at the circuit body 27 and is provided to a target device such as an analyzer or an information processing device via the connector wiring (not shown).

Case

FIGS. 7A through 7C provide illustrations of the case 11 in FIG. 2, with FIG. 7A showing it in a top view, FIG. 7B showing it in a sectional view taken along VIIb-VIIb in FIG. 7A and FIG. 7C showing it in a bottom view.

The case 11 is formed so as to assume a rectangular shape in a plan view. As has been explained earlier, the recessed portion 15 for locking or fixing a magnet, assuming a rectangular shape in a plan view, at which the permanent magnet 61 is to be fixed with an adhesive, is formed in a substantially central area of the inner surface of the bottom portion 11a of the case 11. The recessed portion 15 is formed so as to assume a smaller wall thickness compared to the remaining area of the bottom portion 11a. In addition, the two grooves 16 are formed at the outer surface of the bottom portion 11a of the case 11, i.e., at the bottom surface of the case 11. The grooves 16 extend parallel to each other along the Y direction in the figure. The following explanation will be given by assuming that the movable comb electrode 120 vibrates relative to the fixed comb electrode 110 along the X direction at the vibration energy harvester 100 housed inside the vibration energy harvesting device 10. This means that the Y direction along which the grooves 16 extend runs perpendicular to the direction in which the movable comb electrode 120 vibrates.

Adapter

FIGS. 8A through 8C provide illustrations of the adapter 30 in FIG. 1, with FIG. 8A showing it in a top view, FIG. 8B showing it in a sectional view taken along VIIIb-VIIIb in FIG. 8A and FIG. 8C showing it in a bottom view.

As explained earlier, the adapter 30 is a plate member formed by using a nonmagnetic material such as resin. The adapter 30 assumes a substantially rectangular shape in a plan view, and the lengths of its longer sides and shorter sides respectively match the lengths of the longer sides and the shorter sides of the rectangular bottom surface of the bottom portion 11a of the case 11. As explained earlier, the through holes 31, at which fastening members 62 such as screws or bolts are inserted, are formed near the four corners of the adapter 30. The fastening members 62 in the embodiment are flat-head screws (see FIG. 3). The adapter 30 is locked to the vibration source (not shown) via the fastening members 62 inserted through the through holes 31.

FIGS. 9A and 9B show a structure achieved by attaching the fastening members to the adapter in FIG. 1, with FIG. 9A showing it in a plan view and FIG. 9B showing it in a sectional view taken along IXb-IXb in FIG. 9A.

As shown in FIGS. 9A and 9B, the four fastening members 62 are each inserted through a through hole 31 formed at the adapter 30 and are fastened to the vibration source (not shown). The fastening members 62 are flat-head screws and thus, even when the plate thickness of the adapter 30 is small, the heads of the flat-head screws can be set at positions lower than the upper surface of the adapter 30, as illustrated in FIG. 3. This means that the bottom portion 11a of the case 11 is prevented from coming into contact with the heads of the flat-head screws. In other words, the thickness (full height) of the vibration energy harvesting apparatus can be reduced.

At a front surface 30U of the adapter 30 that faces opposite the bottom portion 11a of the vibration energy harvesting device 10, the two protruding portions 32, extending parallel to each other along the Y direction, are formed.

In a substantially central area of a rear surface 30L of the adapter 30 which is the other side of the front surface 30U where the two protruding portions 32 are formed, a recessed portion 33 for locking a magnet assuming a rectangular shape in a plan view, to which a permanent magnet 67 (see FIG. 3) is fixed, is formed.

As shown in FIG. 3, the permanent magnet 61 is disposed in the recessed portion 15 at the bottom portion 11a of the case 11. The adapter 30 manufactured by using a nonmagnetic material is locked to the vibration energy harvesting device 10 through attraction via the permanent magnets 61 and 67, with the two protruding portions 32 fitted in the two grooves 16 formed at the bottom portion 11a of the case 11. The two grooves 16 at the case 11 and the protruding portions 32 at the adapter 30 function as positioning members, and as the protruding portions 32 of the adapter 30 are fitted in the two grooves at the case 11, the vibration energy harvesting device 10 and the adapter 30 are positioned and held firmly so that they cannot rotate relative to each other. Namely, it is ensured that the vibration energy harvesting device 10 does not become positionally misaligned or rotate relative to the adapter 30 even as the vibration source vibrates.

The permanent magnet 61 disposed in the recessed portion 15 at the case 11 and the permanent magnet 67 disposed in the recessed portion 33 at the adapter 30 are set so that the magnetic polarities at their surfaces facing each other are different from each other. Accordingly, through the attraction between the permanent magnet 61 and the permanent magnet 67, the adapter 30 becomes locked to the bottom portion 11a of the case 11. In this structure, the case 11 and the adapter 30 are locked to each other through the magnetic force even though the case 11 and the adapter 30 are constituted of a nonmagnetic material such as resin.

However, the case 11 and the adapter 30 can be locked to each other with magnetic force imparted by a single permanent magnet 61 or 67 if an attraction-type locking portion that can be locked via the magnetic force is formed in at least part of a surface where the case 11 and the adapter 30 are in contact with each other even when either the case 11 or the adapter 30 is constituted of resin or both the case 11 and the adapter 30 are constituted of resin. The following is an explanation of examples of such structures.

FIG. 22 presents a chart of examples of locking structures achieved through magnetic force acting between the case 11 and the adapter 30.

Examples of members that may be disposed in the recessed portion 15 at the case 11 and in the recessed portion 33 at the adapter 30 when the case 11 and the adapter 30 are each constituted of a nonmagnetic material (notated as “resin” in FIG. 22) or a magnetic material (notated as “metal” in FIG. 22) are indicated in the chart.

In structural examples 1 through 4, the case 11 is formed by using resin, whereas in structural examples 5 through 7, the case 11 is formed by using metal.

Structural examples 1 through 3 adopt a structural pattern 1 with both the case 11 and the adapter 30 constituted of resin. In the structural pattern 1, permanent magnets are disposed, one in the recessed portion 15 at the case 11 and another in the recessed portion 33 at the adapter 30, as indicated in the structural example 1. The structural example 1 represents a structure identical to that described in reference to the embodiment. Alternatively, the structural pattern 1 may include a permanent magnet disposed in the recessed portion 15 at the case 11 and a magnetic material fixed in the recessed portion 33 at the adapter 30, as indicated in the structural example 2. Furthermore, the structural pattern 1 may include a magnetic material fixed in the recessed portion 15 at the case 11 and a permanent magnet disposed in the recessed portion 33 at the adapter 30, as indicated in the structural example 3.

In the structural example 1, permanent magnets are disposed, one in the recessed portion 15 at the case 11 and another in the recessed portion 33 at the adapter 30. In the structural examples 2 and 3, on the other hand, a permanent magnet is disposed in either the recessed portion 15 at the case 11 or the recessed portion 33 at the adapter 30 and a magnetic material is disposed in the other recessed portion. This means that the structural example 1 is preferable, since the case 11 and the adapter 30 are more strongly locked together, due to a greater magnetic force, compared to that achieved in the structural examples 2 and 3.

The structural examples 4 and 5 adopt a structural pattern 2 with either the case of 11 or the adapter 30 formed by using resin and the other formed by using metal.

In the structural pattern 2 adopted in conjunction with the case 11 formed by using resin and the adapter 30 formed by using metal, a permanent magnet is disposed in the recessed portion 15 at the case 11, as indicated in the structural example 4. In the structural example 4, since the adapter 30 is constituted of metal, i.e., since the adapter 30 functions as a magnetic attraction-type locking portion, neither a permanent magnet nor a magnetic material needs to be disposed in the recessed portion 33 at the adapter 30. It is to be noted that the “-” in FIG. 22 indicates that neither a permanent magnet nor a magnetic material is required. In addition, in the structural pattern 2 achieved in conjunction with the case 11 formed by using metal and the adapter 30 formed by using resin, a permanent magnet is fixed in the recessed portion 33 at the adapter 30, as indicated in the structural example 5. In the structural example 5, since the case 11 is constituted of metal, i.e., since the case 11 functions as a magnetic attraction-type locking portion, neither a permanent magnet nor a magnetic material needs to be disposed in the recessed portion 15 at the case 11.

The structural examples 6 and 7 adopt a structural pattern 3 that includes the case 11 and the adapter 30 both formed by using metal.

In the structural pattern 3, with the case 11 and the adapter 30 both constituted of metal, a permanent magnet may be disposed in the recessed portion 33 at the adapter 30, as indicated in the structural example 6. In the structural example 6, the case 11 functions as a magnetic attraction-type locking portion and thus, neither a permanent magnet nor a magnetic material needs to be disposed in the recessed portion 15 at the case 11. In addition, in the structural pattern 3, with the case 11 and the adapter 30 both constituted of metal, a permanent magnet may be disposed inside the recessed portion 15 at the case 11, as indicated in the structural example 7. In the structural example 7, the adapter 30 functions as a magnetic attraction-type locking portion and thus, neither a permanent magnet nor a magnetic material needs to be disposed in the recessed portion 33 at the adapter 30.

It is to be noted that a permanent magnet or a magnetic material may be fixed to the case 11 or the adapter 30 by forming the permanent magnet or the magnetic material as an integrated part of the case 11 or the adapter 30 through injection molding instead of bonding it to the case 11 or the adapter 30.

The first embodiment, having been described in reference to FIG. 1 through FIGS. 9A and 9B, will be explained in further detail.

The power generation efficiency of the vibration energy harvesting device 10 is dependent upon the degree of consistency between the vibrating direction along which the movable comb teeth at the vibration energy harvester 100 vibrate and the vibrating direction along which the vibration source vibrates. Accordingly, the vibration energy harvesting device 10 is mounted by aligning the vibrating direction along which the movable comb teeth vibrate at the vibration energy harvester 100 with the vibrating direction (X direction) along which the vibration source vibrates. The adapter 30 is locked to the vibration source by setting the direction along which the pair of protruding portions 32 extend along a direction (Y direction) running perpendicular to the vibration source vibrating direction (X direction). The pair of protruding portions 32 at the adapter 30 having been locked to the vibration source are each fitted in one of the grooves 16 at the case 11. The case 11 and the adapter 30 are locked together with magnetic force. This means that the vibrating direction X along which the movable comb teeth vibrate at the vibration energy harvesting device 10 matches the vibration source vibrating direction. In addition, since the protruding portions 32 at the adapter 30 and the grooves 16 at the case 11 extend along a direction running perpendicular to the vibration source vibrating direction, the vibration energy harvesting device 10 is not allowed to become misaligned or rotate.

The vibration energy harvester 100 is designed so that the movable comb electrode 120 is able to resonate efficiently with the vibration of the vibration source. This design is bound to impose restrictions with respect to the mounting position, the mounting orientation and the mounting attitude of the vibration energy harvesting device 10 at the vibration source. In addition, since vibration sources come in many different shapes including those assuming a tubular shape in the area where the vibration energy harvesting device 10 is installed, those with curved mounting surfaces and those with irregular mounting surfaces, the mounting conditions under which the vibration energy harvesting device 10 is mounted at the installation location are bound to be different from one vibration source to another. For this reason, the vibration source and the adapter 30 may be locked in an unstable mounting state with, for instance, the mounting surfaces only achieving point contact, and under such circumstances, the efficiency with which the vibration of the vibration source is converted to electric energy will be lowered and the vibration energy harvesting device 10 will not be able to generate electric power as desired.

The adapter 30 in the embodiment is locked to the vibration energy harvesting device 10 with magnetic force, which makes it possible to attach and detach the vibration energy harvesting device 10 to/from the adapter 30 with ease.

Thus, if the target electric power cannot be generated with the vibration energy harvesting device 10 mounted at any given position, the vibration energy harvesting device 10 simply needs to be detached from the adapter 30 and the adapter 30 can be easily mounted at another position at the same vibration source. Once the generated power achieves the desired value, the particular mounting position is deemed to be optimal.

The following advantages and operations are achieved through the embodiment.

(1) The vibration energy harvesting apparatus comprises the case (casing) 11 in which the power generating device 20 comprising the vibration energy harvester 100 and the circuit body (power storage circuit) 27 is housed, the adapter 30 disposed between the case 11 and a vibration source, and a permanent magnet 61 or 67 that locks the case 11 and the adapter 30 together with magnetic force, with the permanent magnet 61 or 67 disposed at least either in the case 11 or at the adapter 30. The vibration energy harvesting device 10, therefore, can easily be attached to or detached from the adapter 30 locked to the vibration source. Otherwise, the expensive vibration energy harvester 100 will have to be discarded if the desired level of power generation efficiency cannot be achieved with the vibration energy harvesting device 10 securely fixed to the vibration source.

In addition, by providing the adapter 30 at a plurality of positions at the vibration source and selecting and mounting the vibration energy harvesting device at an installation position achieving the highest power generation efficiency, the installation position assuring a high level of power generation efficiency can be set. In this manner, even if various vibration sources vibrate along many different directions and the vibrating direction of a given vibration source may not be ascertained in advance, the vibration energy harvesting device 10 can be mounted through fewer mounting steps.

(2) The adapter 30 includes at least an attraction-type locking portion constituted of a magnetic material and the permanent magnet 61 is disposed at least in the case 11. Since the permanent magnet 61 is disposed in the vibration energy harvesting device 10, the vibration energy harvesting device 10 can be locked to the adapter 30 with ease through attraction.

(3) The adapter 30 is locked to the bottom portion 11a of the case 11 and through holes 31 (locking member attaching portions) at which fastening members 62 are mounted are formed at the adapter 30 within an area that overlaps the bottom portion 11a of the case 11 in a plan view. In other words, the locking member attaching portions of the adapter 30 are located within a planar area (inside the edge of the bottom portion) of the bottom portion 11a of the case 11. Thus, the plane size of the adapter 30 and consequently the plane size of the vibration energy harvesting device 10 can be reduced in comparison to those in a structure with the locking member mounting portions of the adapter 30 formed at the outer circumferential edge of the adapter 30.

(4) Protruding portions 32 used for positioning or rotation-prevention are formed at the adapter 30, whereas grooves (protruding portion insertion portions) 16, at which the protruding portions 32 are inserted, are formed at the bottom portion 11a of the case 11. Thus, when the vibration energy harvesting device 10 is locked to the adapter 30, the positions of the vibration energy harvesting device 10 and adapter 30 can be easily set. In addition, rotation of the vibration energy harvesting device 10 relative to the adapter 30, which may be caused by vibration of the vibration source, can be prevented.

### Second Embodiment

FIGS. 10A through 10C illustrate the second embodiment of the present invention, with FIG. 10A showing a case in a top view, FIG. 10B showing the case in a sectional view taken along Xb-Xb in FIG. 10A and FIG. 10C showing the case in a bottom view. FIGS. 11A through 11C illustrate the adapter to be locked to the case in FIGS. 10A through 10C, with FIG. 11A showing the adapter in a top view, FIG. 11B showing it in a sectional view taken along XIb-XIb in FIG. 11A and FIG. 11C showing it in a bottom view.

The second embodiment adopts a structure that includes two grooves 16a formed as pinholes, as shown in FIG. 10C, instead of the two linear grooves 16 running parallel to each other formed at the bottom portion 11a of the case 11 in the first embodiment. The pair of grooves 16a are formed so as to achieve line symmetry or point symmetry relative to the center of a recessed portion 15 formed at the inner surface of the bottom portion 11a of the case 11.

In addition, in correspondence to the particular structural feature of the grooves 16a at the case 11, two protruding portions 32a assuming a pin shape are formed at the adapter 30, as illustrated in FIGS. 11A and 11B. The protruding portions 32a are formed at positions and in a size that will allow them to fit in the pinhole-shaped grooves 16a formed at the bottom portion 11a of the case 11. In the second embodiment too, the two grooves 16a at the case 11 and the protruding portions 32a at the adapter 30 function as positioning members, and the positions of the case 11 and the adapter 30 are set as the protruding portions 32a of the adapter 30 are fitted in the two grooves 16a at the case 11. In addition, with the protruding portions 32a of the adapter 30 fitted in the two grooves 16a at the case 11, rotation of the vibration energy harvesting device 10 and the adapter 30 relative to each other is prevented.

It is to be noted that the pinhole-shaped grooves 16a may be formed at positions asymmetrical to each other and the protruding portions 32a, too, may be formed at positions asymmetrical to each other and that three or more grooves 16a may be formed.

Other structural features of the second embodiment are similar to those of the first embodiment.

Accordingly, advantages and operations similar to the advantages and operations of the first embodiment described in (1) through (4) are also achieved through the second embodiment. Recessed portions may be formed in place of the protruding portions 32a at the adapter 30 and locking pins may be inserted through the pinholes 16a and the recessed portions.

### Third Embodiment

FIGS. 12A through 12C illustrate the third embodiment of the present invention, with FIG. 12A showing a case in a top view, FIG. 12B showing the case in a sectional view taken along XIIb-XIIb in FIG. 12A and FIG. 12C showing the case in a bottom view. FIGS. 13A through 13C illustrate the adapter to be locked to the case in FIGS. 12A through 12C, with FIG. 13A showing the adapter in a top view, FIG. 13B showing it in a sectional view taken along XIIIb-XIIIb in FIG. 13A and FIG. 13C showing it in a bottom view.

In the third embodiment, grooves 16a are not formed at the bottom portion 11a of the case 11, and instead, groove portions 16b are formed at the bottom ends of a pair of side portions 11b of the case 11 facing opposite each other, as illustrated in FIG. 12B and FIG. 12C. The pair of groove portions 16b are formed so as to achieve line symmetry or point symmetry relative to the center of a recessed portion 15 formed at the inner surface of the bottom portion 11a of the case 11.

In addition, in correspondence to the particular structural feature of the groove portions 16b at the case 11, a pair of protruding pieces 32b are formed at the adapter 30, as illustrated in FIGS. 13A through 13C. Provided that the protruding pieces 32b are constituted of metal, the adapter 30 can be formed by creating notches 72 at the case 11 and forming the protruding pieces 32b with the notches 72 bent at a substantial right angle through press-machining. Provided that the protruding pieces 32b are constituted of resin, the adapter 30 may be formed through molding. As an alternative, the protruding pieces 32b may be formed as metal pieces and the adapter 30 may be formed through insert molding. Two two-point chain lines 73 in FIGS. 12A through 12C and FIGS. 13A through 13C indicate the respective positions of inner side surfaces of the groove portions 16b of the case 11. As FIGS. 12A through 12C and FIGS. 13A through 13C indicate, the positions taken by the inner surfaces of the protruding pieces 32b match the positions taken by the inner side surfaces of the corresponding groove portions 16b of the case 11.

Thus, the two protruding pieces 32b at the adapter 30 can be fitted in the two groove portions 16b at the case 11.

In the third embodiment too, the two groove portions 16b at the case 11 and the protruding pieces 32b at the adapter 30 function as positioning members, and the positions of the case 11 and the adapter 30 are set as the protruding pieces 32b of the adapter 30 are fitted in the two groove portions 16b at the case 11. In addition, with the protruding pieces 32b of the adapter 30 fitted in the two groove portions 16b at the case 11, rotation of the vibration energy harvesting device 10 and the adapter 30 relative to each other is prevented.

Other structural features of the third embodiment are similar to those of the first embodiment.

Accordingly, advantages and operations similar to the advantages and operations of the first embodiment described in (1) through (4) are also achieved through the third embodiment.

### Fourth Embodiment

FIGS. 14A and 14B illustrate the fourth embodiment of the present invention, with FIG. 14A showing an adapter in a top view and FIG. 14B showing it in a sectional view taken along XIVb-XIVb in FIG. 14A.

In the fourth embodiment, the adapter 30 and the vibration source are locked together through adhesion instead of through fastening via the fastening members 62, as in the first embodiment.

In the fourth embodiment, an area other than the central area is formed as a planar surface at a rear surface 30L of the adapter 30, which is the other side of a front surface 30U where the protruding portions 32 are formed and an adhesive 74 is disposed at the rear surface 30L. The adhesive 74 may be a double-sided adhesive tape with a thermo-setting glue or an ultraviolet-setting glue applied to both sides, a double-sided adhesive tape with a cold-setting glue applied to both sides, or the like. In addition, a fluid adhesive may be applied to the adapter 30.

It is to be noted that the adapter 30 illustrated in FIGS. 14A and 14B includes through holes 31 in which fastening members 62 are to be inserted. This means that the adapter 30 in the fourth embodiment can also be locked to the vibration source via fastening members 62 (see FIG. 3), allowing the choice as to whether to lock the adapter 30 with the adhesive 74 or with the fastening members 62.

Other structural features of the fourth embodiment are similar to those of the first embodiment.

This means that the adapter 30 is locked to the case 11 through magnetic force and the projecting portions 32 at the adapter 30 are fitted in the grooves 16 at the bottom portion 11a of the case 11 in the fourth embodiment by adopting structural features similar to those of the first embodiment.

Accordingly, advantages and operations similar to the advantages and operations of the first embodiment described in (1) through (4) are achieved through the fourth embodiment.

### Fifth Embodiment

FIGS. 15A through 15C illustrate the fifth embodiment of the present invention, with FIG. 15A showing an adapter in a front view, FIG. 15B showing the adapter in a bottom view and FIG. 15C showing the adapter in a sectional view taken along XVc-XVc in FIG. 15A.

The adapter 30 in the fifth embodiment includes a case locking portion 37a and a vibration source locking portion 37b. The case locking portion 37a and the vibration source locking portion 37b extend along directions running at a right angle to each other, forming the shape of the letter L in a sectional view. The adapter 30 may be formed with a magnetic metal material by bending the metal so as to form the case locking portion 37a and the vibration source locking portion 37b through press-machining. As an alternative, the adapter 30 may be formed through molding.

At the case locking portion 37a, two protruding portions 32, which will be fitted in the grooves 16 at the bottom portion 11a of the case 11, are formed. At the vibration source locking portion 37b, through holes 31, at which fastening members 62 used to lock the adapter 30 to the vibration source either directly or indirectly, are formed.

The bottom portion 11a of the case 11 is locked by fitting the protruding portions 32 at the case locking portion 37a of the adapter 30 into the grooves 16 at the case 11 over the XY surface of the case locking portion 37a of the adapter 30 shown in FIG. 15A. In this state, the vibrating direction along which the movable comb electrode 120 at the vibration energy harvester 100 vibrates runs perpendicular to the protruding portions 32. In addition, the vibration source is locked to the YZ surface of the vibration source locking portion 37b of the adapter 30 shown in FIG. 15B.

The fifth embodiment allows the vibration energy harvesting device 10 to be disposed with its attitude shifted by 90° relative to the locking surface of the vibration source. For instance, there may be instances in which the adapter cannot be mounted at a horizontal surface of a vibration source that vibrates along the horizontal direction. Under such circumstances, the vibration source locking portion 37b of the adapter 30 may be mounted at, for instance, a vertical portion of the outer surface of the vibration source and the vibration energy harvesting device 10 may be mounted at the case locking portion 37a of the adapter 30 by ensuring that the movable comb teeth vibrating direction is aligned along the horizontal direction. Namely, the adapter 30 includes the case locking portion 37a and the vibration source locking portion 37b extending along directions that run at an angle to each other such that the vibration source vibrating direction and the comb teeth vibrating direction are aligned.

It is to be noted that in the example described above, the case locking portion 37a and the vibration source locking portion 37b extend so as to run at a right angle to each other. However, the present invention is not limited to this example, as long as the case locking portion 37a and the vibration source locking portion 37b connect with each other over an intersecting area with one extending at a specific angle relative to the other.

Other structural features of the fifth embodiment are similar to those of the first embodiment.

Accordingly, advantages and operations similar to the advantages and operations of the first embodiment described in (1) through (4) are also achieved through the fifth embodiment. In addition, through the fifth embodiment, which includes the case locking portion 37a and the vibration source locking portion 37b disposed at an angle relative to each other, the case locking portion 37a can be oriented along the horizontal direction even when the locking surface of the vibration source is not oriented along the horizontal direction. In other words, the adapter 30 itself adopts an angle adjustment structure for the case locking portion 37a and the vibration source locking portion 37b, which eliminates the need for using an intermediate member, such as an attachment, for purposes of angle adjustment, disposed between the adapter 30 and the vibration source. As a result, an advantage is achieved in that the number of required parts can be reduced and the manufacturing cost can be lowered.

### Sixth Embodiment

FIGS. 16A through 16C illustrate the sixth embodiment of the present invention, with FIG. 16A showing an adapter with locking members included therein in a top view, FIG. 16B showing the adapter in a sectional view taken along XVIb-XVIb in FIG. 16A and FIG. 16C showing the adapter with the locking members in a bottom view.

The sixth embodiment includes locking members constituted with permanent magnets 69, used to lock the adapter 30 to the vibration source, instead of the fastening members 62 used as the locking members in the first embodiment. Three grooves 34 are formed at the adapter 30 on the side which is to face opposite a locking surface 91 of the vibration source (see FIG. 3). The three grooves 34 are set at positions each taking the position of a vertex of a triangle. A spherical permanent magnet 69 is fixed in each groove 34. The permanent magnets 69 may be fixed onto the bottom surfaces of the grooves 34 with, for instance, an adhesive. As an alternative, the adapter 30 may be formed through insert molding by setting the permanent magnets 69 as insert members. It is to be noted that the permanent magnets 69 are indicated with dotted lines in FIG. 16A for clarity.

The adapter 30 is locked to the locking surface of the vibration source with the three dot-like permanent magnets 69. Since the adapter 30 is locked via the three dot-like permanent magnets 69, which form a single plane, the adapter 30 can be locked to the vibration source stably even if the vibration source locking surface is irregular.

Other structural features of the sixth embodiment are similar to those of the first embodiment.

Accordingly, advantages and operations similar to the advantages and operations of the first embodiment described in (1) through (4) are also achieved through the sixth embodiment. In addition, in the sixth embodiment, the permanent magnets 69 fixed to the adapter 30 can be locked onto the locking surface of the vibration source through three-point attraction, which makes it possible to lock the adapter 30 to the vibration source with high efficiency regardless of the shape of the vibration source mounting surface, i.e., even if the mounting surface is not flat.

### Seventh Embodiment

FIGS. 17A through 17C illustrate the seventh embodiment of the present invention, with FIG. 17A showing an adapter with locking members included therein in a top view, FIG. 17B showing the adapter in a sectional view taken along XVIIb-XVIIb in FIG. 17A and FIG. 17C showing the adapter with the locking members in a bottom view.

The seventh embodiment is achieved by replacing the spherical permanent magnets 69 in the sixth embodiment with bar-shaped permanent magnets 69a.

On the side of the adapter 30 that faces opposite a locking surface 91 of the vibration source, a pair of grooves 35 are formed so as to extend along the Y direction, i.e., the direction along which the protruding portions 32 extend. The pair of grooves 35 are set at positions achieving symmetry relative to a center line of the adapter 30 in the X direction. A bar-shaped permanent magnet 69a is fixed in each groove 35. The permanent magnets 69a may be fixed onto the bottom surfaces of the grooves 35 with, for instance, an adhesive. As an alternative, the adapter 30 may be formed through injection molding by setting the permanent magnets 69a as insert members.

The adapter 30 is locked onto the locking surface 91 of the vibration source with the pair of bar-shaped permanent magnets 69a. Since the pair of bar-shaped permanent magnets 69a are disposed at positions achieving symmetry relative to the center line of the adapter 30 in the X direction, the adapter 30 can be locked to the vibration source with a high degree of reliability even when the vibration source locking surface 91 is curved in a circular shape or an elliptical shape in a sectional view, as illustrated in FIG. 17B.

Other structural features of the seventh embodiment are similar to those of the first embodiment.

Accordingly, advantages and operations similar to the advantages and operations of the first embodiment described in (1) through (4) are also achieved through the seventh embodiment. In addition, in the seventh embodiment, the bar-shaped permanent magnets 69a fixed to the adapter 30 can be locked onto the locking surface 91 of the vibration source through attraction, which makes it possible to lock the adapter 30 to the vibration source with high efficiency. Furthermore, since the pair of bar-shaped permanent magnets 69a disposed at the adapter 30 extend along the direction matching the direction in which the protruding portions 32 extend, the adapter 30 can be locked to a vibration source having the locking surface 91 which is curved in a circular arc.

### Eighth Embodiment

FIGS. 18A through 18C illustrate the eighth embodiment of the present invention, with FIG. 18A showing an adapter with locking members included therein in a top view, FIG. 18B showing it in a sectional view taken along XVIIIb-XVIIIb in FIG. 18A and FIG. 18C showing the adapter in FIG. 18A in a side elevation.

The eighth embodiment includes locking members used to lock the adapter 30 to the vibration source, which are constituted with a pair of tie locks, widely referred to as zip ties.

Tie locks 81 each include a tie holding portion 82, a tie (i.e., a fastening band) 83 and a retainer portion 84.

The tie 83 is attached so as to run through an opening 82a formed in the tie holding portion 82 and extend along a direction (X direction) running perpendicular to the direction along which the protruding portions 32 extend at the adapter 30 (Y direction). The retainer portion 84 is disposed at one end of the tie 83. The retainer portion 84 includes an opening 84a and a retainer piece 84b projecting out at the opening 84a. The other end of the tie 83 is inserted through the opening 84a and is retained with the retainer piece 84b.

A pair of through holes 31a are formed at the adapter 30 at positions present on a center line of the adapter 30 in the X direction. The tie holding portions 82 of the tie locks 81 are respectively disposed near the two ends of the adapter 30 located opposite each other along the Y direction, and are locked to the adapter 30 via fastening members 75, such as screws, inserted at the through holes 31a.

The tie locks 81 are each locked to the vibration source by wrapping the tie 83 around the outer edge of the vibration source and retaining the other end of the tie with the retainer piece 84 so that it binds the vibration source.

The tie locks 81 in the eighth embodiment are particularly effective when the vibration source assumes a tubular shape such as the shape of a circular cylinder or the shape of a prismatic column.

Other structural features of the eighth embodiment are similar to those of the first embodiment.

Accordingly, advantages and operations similar to the advantages and operations of the first embodiment described in (1) through (4) are also achieved through the eighth embodiment.

### Ninth Embodiment

FIG. 19 shows the ninth embodiment of the present invention in a sectional view.

An adapter 30 in the ninth embodiment adopts a structure whereby it is locked onto an attachment 40 which, in turn, is locked to a vibration source 90 indicated by the two-point chain line. In other words, the adapter 30 is locked to the vibration source 90 via the attachment 40 used as an intermediate member.

The attachment 40 includes a frame 41 and an elevator portion 42. The frame 41 includes a connecting portion 41a, a locking portion 41b and a holding portion 41c. The connecting portion 41a, the locking portion 41b and the holding portion 41c are formed as an integrated unit, with the locking portion 41b and the holding portion 41c bent at a substantially right angle relative to the connecting portion 41a at the two ends of the connecting portion 41a.

The elevator portion 42 includes an externally threaded portion 42a, a pressure contact portion 42b and a knob portion 42c. The externally threaded portion 42a interlocks with an internally threaded portion (not shown) at the frame 41 and as the knob portion 42c is rotated, the elevator portion 42 moves up/down relative to the frame 41.

As the knob portion 42c is rotated with the vibration source 90 placed between the locking portion 41b of the frame 41 and the pressure contact portion 42b of the elevator portion 42, the attachment 40 is locked to the vibration source 90 held between the locking portion 41b of the frame 41 and the pressure contact portion 42b of the elevator portion 42. In this mounting structure, the attachment 40 and the vibration source are locked together through clamping, and such a clamp mounting structure can be adopted regardless of whether the vibration source 90 is constituted of a magnetic material or a nonmagnetic material.

Three through holes 31 and 31a are formed at the adapter 30 at positions set apart along the X direction. The adapter 30 is fastened by inserting fastening members 62 at the two through holes 31 formed near the two ends thereof and interlocking the fastening members 62 with internally threaded portions 76 formed at the locking portion 41b of the frame 41. It is to be noted that another through hole 31a formed between the two through holes 31 located near the two ends of the adapter 30 may be used for purposes of locking the adapter 30 and the attachment 40 together. However, the through hole 31a does not need to be used for this purpose. The purpose of the through hole 31a will be explained in reference to the tenth embodiment.

The vibration energy harvesting device mounting structure in the ninth embodiment is effective when the vibration source is a thin, flat plate.

Other structural features of the ninth embodiment are similar to those of the first embodiment.

Accordingly, advantages and operations similar to the advantages and operations of the first embodiment described in (1) through (4) are also achieved through the ninth embodiment. In addition, the adapter 30 is locked to the vibration source 90 via the attachment 40 used as an intermediate member in the ninth embodiment. Since the attachment 40 and the vibration source 90 are locked together through clamping, there is an added advantage in that the mounting structure can be adopted regardless of whether the vibration source 90 is constituted of a magnetic material or a nonmagnetic material.

### Tenth Embodiment

FIGS. 20A through 20C illustrate the tenth embodiment of the present invention, with FIG. 20A showing an adapter in a top view, FIG. 20B showing the adapter in FIG. 20A in a side elevation and FIG. 20C showing the adapter in a bottom view.

The adapter 30 in FIGS. 20A through 20C includes a plurality of locking member mounting portions used to mount a plurality of different types of locking members for locking the adapter 30 to the vibration source.

At a front surface 30U of the adapter 30, which faces opposite the bottom portion 11a of the vibration energy harvesting device 10, two protruding portions 32 are formed so as to extend parallel to each other along the Y direction in the figures. A rear surface 30L, located on the other side of the front surface 30U, is formed as a planar surface without any protruding portions. At a substantial center of the rear surface 30L of the adapter 30, a magnet locking recessed portion 33, where a permanent magnet 67 is to be fixed, is formed. This structure is similar to that of the first embodiment.

Through holes 31 (first locking member mounting portions) are each formed at one of the four corners of the adapter 30. As fastening members 62 are inserted at the through holes 31, the adapter with locking members having been described in reference to the first embodiment (see, for instance, FIGS. 9A and 9B) is achieved.

The rear surface 30L of the adapter 30 is formed as a planar surface (second locking member mounting portion), and as an adhesive 74 such as a double-sided tape is applied to the rear surface, the adapter with a locking member having been described in reference to the fourth embodiment (see FIGS. 14 A and 14B) is achieved.

At the rear surface 30L of the adapter 30, three grooves 34 (third locking member mounting portions), each assuming the shape of a pinhole, are formed. The three grooves 34 are each formed at positions at one of the vertices of a triangle. As spherical permanent magnets 69 are fixed inside the individual grooves 34, the adapter with locking members having been described in reference to the sixth embodiment (see FIGS. 16A through 16C) is achieved.

At the rear surface 30L of the adapter 30, a pair of grooves 35 (fourth locking member mounting portions) are formed in straight lines extending along the Y direction matching the direction along which the protruding portions 32 extend. The pair of grooves 35 are formed at positions achieving symmetry relative to a center line of the adapter 30 in the X direction. As bar-shaped permanent magnets 69 are fixed inside the individual grooves 35, the adapter with locking members having been described in reference to the seventh embodiment (see FIGS. 17A through 17C) is achieved.

At the adapter 30, a pair of through holes 31a (fifth locking member mounting portions) are formed at positions taken on the center line of the adapter 30 in the X direction. As fastening members 75 are inserted through the through holes 31a and the tie locks 81 are locked, the adapter with locking members having been described in reference to the eighth embodiment (see FIGS. 18A through 18C) is achieved.

Namely, the adapter 30 in FIGS. 20A through 20C includes a plurality of locking member mounting portions at which a plurality of different types of fastening members, such as the fastening members 62, the adhesive 74, the spherical permanent magnets 69, the bar-shaped permanent magnets 69a and the tie locks 81, can be mounted.

Other structural features of the tenth embodiment are similar to those of the first embodiment.

Accordingly, advantages and operations similar to the advantages and operations of the first embodiment described in (1) through (4) are also achieved through the tenth embodiment. In addition, the adapter 30 in the tenth embodiment includes a plurality of locking member mounting portions at which a plurality of different types of fastening members are mounted. This means that the adapter 30 can be locked to the vibration source via locking members optimal for the particular vibration source, which may be formed of any material and in any shape. In other words, the adapter 30 can be utilized as a universal adapter, which, in turn, makes it possible to achieve cost reduction.

It is to be noted that the adapter 30 does not need to include all the locking member mounting portions, i.e., the first through sixth locking member mounting portions. The adapter 30 may only include a plurality of locking member mounting portions that allow a plurality of different types of common locking members that are likely to be employed.

### Eleventh Embodiment

FIGS. 21A through 21D illustrate the eleventh embodiment of the present invention, with FIG. 21A showing an adapter in a top view, FIG. 21B showing the adapter in a plan view, FIG. 21C showing the adapter in a bottom view and FIG. 21D showing the adapter in FIG. 21B in a side elevation.

The adapter 30 in the eleventh embodiment includes a plurality of locking member mounting portions that will allow the adapter 30 in the fifth embodiment (see FIGS. 15A through 15C) to be locked to vibration sources via a plurality of different types of locking members mounted at the locking member mounting portions as has been explained in reference to the tenth embodiment.

The adapter 30 in the eleventh embodiment includes a case locking portion 37a and a vibration source locking portion 37b. The case locking portion 37a and the vibration source locking portion 37b extend along directions running at a right angle to each other, forming the shape of the letter L in a sectional view.

At the case locking portion 37a, two protruding portions 32, which will be fitted in the grooves 16 at the bottom portion 11a of the case 11, are formed. At the vibration source locking portion 37b, through holes 31, at which the fastening members 62 to be locked to a vibration source are inserted, are formed.

The bottom portion 11a of the case 11 is locked by fitting the protruding portions 32 at the case locking portion 37a of the adapter 30 into the grooves 16 at the case 11 over the XY surface of the case locking portion 37a of the adapter 30 shown in FIG. 21B. In this state, the vibrating direction along which the movable comb electrode 120 at the vibration energy harvester 100 vibrates, runs perpendicular to the protruding portions 32. In addition, the vibration source is locked to the XZ surface of the vibration source locking portion 37b of the adapter 30 shown in FIG. 21C.

Through holes 31 (first locking member mounting portions) are each formed at one of the four corners of the vibration source locking portion 37b of the adapter 30. A fastening member 62 is inserted at each through hole 31. A lower surface 38 of the vibration source locking portion 37b at the adapter 30, which will face opposite the vibration source, is formed as a planar surface (second locking member mounting portion) and an adhesive 74, such as double-sided tape, can be applied to the rear surface.

At the lower surface 38 of the vibration source locking portion 37b at the adapter 30, three grooves 34 (third locking member mounting portions), are formed. The three grooves 34 are set at positions each taking the position of vertex of a triangle. Spherical permanent magnets 69 can be fixed in the grooves 34.

At the lower surface 38 of the vibration source locking portion 37b at the adapter 30, a pair of grooves 35 (fourth locking member mounting portions) are formed. The pair of grooves 35 are formed at positions achieving symmetry relative to a center line of the adapter 30 in the X direction. Bar-shaped permanent magnets 69a can be fixed in the grooves 35.

At the vibration source locking portion 37b of the adapter 30, a pair of through holes 31a (fifth locking member mounting portions) are formed. Tie locks 81 can be secured by inserting fastening members 75 at the through holes 31a.

Namely, the adapter 30 in FIGS. 21A through 21D includes a plurality of locking member mounting portions at which a plurality of different types of fastening members, such as the fastening members 62, the adhesive 74, the spherical permanent magnets 69, the bar-shaped permanent magnets 69a and the tie locks 81, can be mounted.

Other structural features of the eleventh embodiment are similar to those of the first embodiment.

Accordingly, advantages and operations similar to the advantages and operations of the first embodiment described in (1) through (4) are also achieved through the eleventh embodiment. In addition, the adapter 30 in the eleventh embodiment includes a plurality of locking member mounting portions at which a plurality of different types of fastening members are mounted. This means that the adapter 30 can be locked to the vibration source via locking members optimal for the particular vibration source, which may be formed of any material and in any shape. In other words, the adapter 30 can be utilized as a universal adapter, which, in turn, makes it possible to achieve cost reduction.

The eleventh embodiment allows the vibration energy harvesting device 10 to be disposed with its attitude shifted by 90° relative to the locking surface of the vibration source. Thus, advantages and operations similar to those of the fifth embodiment are achieved.

It is to be noted that in the example described above, the case locking portion 37a and the vibration source locking portion 37b extend so as to run at a right angle to each other. However, the present invention is not limited to this example, as long as the case locking portion 37a and the vibration source locking portion 37b connect with each other over an intersecting area with one extending at a specific angle relative to the other.

FIG. 23 is a chart presenting examples of locking structures optimal for vibration sources formed in specific shapes by using specific materials.

When the vibration source is constituted of a nonmagnetic material and has a smooth, planar locking surface:

Provided that the vibration source can be machined, the fastening members 62, such as screws, in the first embodiment shown in FIG. 1 are suitable as locking members, as indicated in structural example 1.

If the vibration source cannot be machined with ease or cannot be machined at all, the adhesive 74 in the fourth embodiment shown in FIGS. 14A and 14B is suitable as a locking member as indicated in structural example 2.

When the locking surface of the vibration source is planar overall, but has superficial irregularities:

If the vibration source is constituted of a nonmagnetic material, the adhesive 74, in the fourth embodiment shown in FIGS. 14A and 14B is suitable as a locking member as indicated in structural example 3. It is desirable, however, that the adhesive 74 have a sufficient thickness to accommodate the superficial irregularities.

If the vibration source is constituted of a magnetic material, the plurality (preferably three or more) of dot-like permanent magnets 69 in the sixth embodiment shown in FIGS. 16A through 16C are suitable as locking members as indicated in structural example 4.

If the vibration source is constituted with a thin, flat plate member that does not assure sufficient strength to securely hold the vibration energy harvesting device 10 and the adapter 30, the attachment 40, such as a clamping holder, in the ninth embodiment shown in FIG. 19 is suitable as a locking member as indicated in structural example 5. The vibration source used in conjunction with this locking member may be constituted of a nonmagnetic material, as well as a magnetic material.

When the vibration source takes a tubular shape such as the shape of a circular column or the shape of a prismatic column:

Provided that the vibration source is constituted of a magnetic material, the bar-shaped permanent magnets 69a, set apart from each other in the seventh embodiment shown in FIGS. 17A through 17C, are suitable as locking members as indicated in structural example 6.

Provided that the vibration source is constituted of a nonmagnetic material, the tie locks 81 in the eighth embodiment shown in FIGS. 18A through 18C are suitable as locking members as indicated in structural example 7.

Variations

FIG. 24 presents an example of a variation of the vibration energy harvesting apparatus according to the present invention in a sectional view. In the first embodiment, the protruding portions 32 formed at the adapter 30 are fitted in the grooves 16 formed at the bottom portion 11a of the case 11.

In contrast, projecting portions 32a are formed at the bottom portion 11a of the case 11, grooves 16a are formed at the adapter 30 and the protruding portions 32a at the case 11 are fitted in the grooves 16a at the adapter 30 in the variation shown in FIG. 24.

Namely, no limitations are imposed with respect to the locations of the grooves and the protruding portions used to determine the positions of the case 11 and the adapter 30 relative to each other and prevent rotation of the case 11 and the adapter 30 relative to each other, i.e., the grooves or the protruding portions may be located either at the case 11 or the adapter 30.

The vibration energy harvesting device 10 and the adapter 30 are locked together through magnetic force. This means that the vibration energy harvesting device 10 and the adapter 30 do not need to be held in a locked state at all times and instead may be separated from each other when they are transported or not in use. In addition, they may be provided as a package in a separated state. In other words, the vibration energy harvesting device 10 and the adapter 30 in a separated state may constitute a kit.

When forming the case 11 and the adapter 30 in the embodiments by using a magnetic material, it is not necessary to form them with a magnetic material in their entirety. Instead, only the areas thereof that face opposite the permanent magnet 61 housed in the case 11 may be formed as locking portions by using a magnetic material.

The vibration energy harvesting device 10 in the embodiments is configured by housing the power generating device 20 and the circuit body 27 formed as an integrated unit inside the casing 11. However, it is not necessary that the power generating device 20 and the circuit body 27 be housed inside a single casing 11. The circuit body 27 may instead be mounted outside the casing 11. For instance, the circuit body 27 may be mounted atop the casing 11 or it may be mounted at the adapter 30.

While various embodiments and variations thereof have been described, the present invention is in no way limited to the particulars of these examples. The various embodiments and the variations thereof may be adopted in combination or they may be modified as necessary, and any other modes conceivable within the scope of the technical teaching of the present invention are also within the scope of the present invention.

### REFERENCE SIGNS LIST

10 vibration energy harvesting device
11 case (casing)
11a bottom portion
16, 16a groove (protruding portion insertion portion)
20 power generating device
21 power generation package
27 circuit body (power storage circuit)
30 adapter
31, 31a through hole (locking member mounting portion)
32, 32a protruding portion
33 recessed portion
34, 35 groove (locking member mounting portion)
37a case locking portion (casing locking portion)
37b vibration source locking portion
40 attachment
61, 67 permanent magnet
62, 75 fastening member (locking member)
69, 69a permanent magnet (locking member)
74 adhesive (locking member)
81 tie lock (locking member)
90 vibration source
91 locking surface
100 vibration energy harvester

1. A vibration energy harvesting apparatus, comprising:
a vibration energy harvesting device in which at least a vibration energy harvester is housed in a casing;
an adapter disposed between the casing and a vibration source; and
a permanent magnet that locks the casing and the adapter together with magnetic force, wherein:
the permanent magnet is disposed at least either inside the casing or at the adapter.

2. The vibration energy harvesting apparatus according to claim 1, further comprising:
a locking member that locks the adapter to the vibration source either directly or via an attachment.

3. The vibration energy harvesting apparatus according to claim 2, wherein:
the adapter includes a locking member mounting portion used to mount the locking member.

4. The vibration energy harvesting apparatus according to claim 2, wherein:
the adapter includes at least an attraction-type locking portion of a magnetic material and the permanent magnet is disposed at least inside the casing.

5. The vibration energy harvesting apparatus according to claim 3, wherein:
the permanent magnet is disposed at the locking member mounting portion of the adapter and the casing includes an attraction-type locking portion of a magnetic material.

6. The vibration energy harvesting apparatus according to claim 3, wherein:
the adapter is locked to a bottom portion of the casing; and
the locking member mounting portion at the adapter is disposed within an area that overlaps the bottom portion of the casing in a plan view.

7. The vibration energy harvesting apparatus according to claim 6, wherein:
a protruding portion used for positioning or rotation prevention is disposed either at the adapter or at the bottom portion of the casing, and a protruding portion insertion portion at which the protruding portion is inserted is disposed at either the adapter or at the bottom portion of the casing where the protruding portion is absent.

8. The vibration energy harvesting apparatus according to claim 3, wherein:
the adapter includes a casing locking portion to be locked to the casing and a vibration source locking portion to be locked to the vibration source or to the attachment, and the casing locking portion and the vibration source locking portion are connected with each other at an intersecting area with one inclined at a predetermined angle relative to another.

9. The vibration energy harvesting apparatus according to claim 2, wherein:
the locking member includes a plurality of permanent magnets that lock the adapter and the vibration source together with magnetic force, disposed at positions set apart from one another.

10. The vibration energy harvesting apparatus according to claim 3, wherein:
the locking member mounting portion at the adapter includes a plurality of locking member mounting portions used to mount a plurality of different types of locking members.

11. A vibration energy harvesting apparatus kit, comprising:
a vibration energy harvesting device in which at least a vibration energy harvester is housed in a casing; and
an adapter disposed between the casing and a vibration source, wherein:
the casing and the adapter are locked together with magnetic force by a permanent magnet disposed at least either inside the casing or at the adapter.

12. A mounting structure for the vibration energy harvesting apparatus according to claim 2, wherein:
the adapter, to which the casing of the vibration energy harvesting device is locked with magnetic force, is locked to the vibration source via the locking member.

13. The vibration energy harvesting device included in the vibration energy harvesting apparatus according to claim 1.

14. An adapter that locks a vibration energy harvesting device with magnetic force and is locked to a vibration source via a locking member, comprising:
a plurality of locking member mounting portions used to mount a plurality of different types of locking members.
